(19) United States
(12) Patent Application Publication
(10) Pub. No.: US 2008/0185341 A1
(43) Pub. Date: Aug. 7, 2008

(54) Water treatment by dendrimer-enhanced filtration

(75) Inventor: Mamadou S. Diallo, Pasadena, CA (US)

Correspondence Address: THELEN REID BROWN RAYSMAN & STEINER LLP, PO BOX 640640, SAN JOSE, CA, 95164-0640, US

(73) Assignee: California Institute of Technology, Pasadena, CA (US)

(21) Appl. No.: 11/888,498

(22) Filed: Jul. 31, 2007

Related U.S. Application Data
(63) Continuation-in-part of application No. 11/182,314, filed on Jul. 15, 2005.
(60) Provisional application No. 60/588,626, filed on Jul. 16, 2004.

(51) Int. Cl. C02F 1/42; C02F 1/64; C02F 1/68; C02F 1/50; C02F 1/76

(52) U.S. Cl. 210/651; 210/682; 210/683; 210/749; 210/764; 210/753

(57) ABSTRACT

Described herein are compositions and methods useful for the purification of aqueous fluids using dendritic macromolecules. The process involves using dendritic macromolecules (dendrimers) to bind to or chemically transform solutes, and a filtration step to produce fluid from which solutes have been removed or chemically transformed. Examples of dendrimers that may be used in the process include cation-binding dendrimers, anion-binding dendrimers, organic compound-binding dendrimers, redox-active dendrimers, biological compound-binding dendrimers, catalytic dendrimers, biocidal dendrimers, viral-binding dendrimers, multi-functional dendrimers, and combinations thereof. The process is readily scalable and provides many options for customization.

### RELATED APPLICATIONS

This application is a continuation-in-part of U.S. application Ser. No. 11/182,314, filed Jul. 15, 2005, which claims benefit of priority from U.S. Provisional Application Ser. No. 60/588,626, filed Jul. 15, 2004. The entire contents of both applications are incorporated herein by reference.

### GOVERNMENT RIGHTS

The United States Government has certain rights in this invention pursuant to Grant Nos. CTS-0086727, CTS-0329436, and NIRT CBET 0506951 awarded by the National Science Foundation.

### FIELD OF THE INVENTION

The invention relates to the fields of dendrimer chemistry, ion exchange, ultrafiltration, and water purification.

### BACKGROUND OF THE INVENTION

Clean water is essential to human health, and is a critical feedstock in the electronics, pharmaceutical and food industries. Treatment of groundwater, lake and reservoir water is often required to make water safe for human consumption. For wastewater, treatment is necessary to remove harmful pollutants from domestic and industrial liquid waste so that it is safe to return to the environment. Current water treatment systems are generally large, centralized systems that employ a number of steps, including treatment with anaerobic organisms, oxidizers, chlorine, and flocculants.

Because of their inherent flexibility, smaller decentralized water treatment systems could provide a more robust and cost effective means for dealing with declining quality of freshwater sources, more stringent water quality standards, and chemical and biological threats to local water supplies. It has been proposed that distributed optimal technology networks (DOT-NET) are an alternative to the large, centralized water treatment plants. The DOT-NET concept is predicated upon the distribution and strategic placement of relatively small and highly efficient treatment systems at specific locations in existing water supply networks. Filtration processes that remove specific contaminants are a key aspect of decentralized water treatment systems.

A number of water filtration processes have designed to remove organic compounds and metal ions from contaminated wastes been described in the literature. Two such processes are micellar-enhanced ultrafiltration (MEUF) (Scamehom and Harwell, (1988) In Surfactant Based Separation Processes, Surfactant Science Series, Vol 33, Marcel Dekker, New York, Dunn et al., (1989) Coll. Surf. 35:49, Baek et al., (2004) J. Haz. Mater. 1081:19, Richardson et al., (1999) J. Appl. Polym. Sci. 4:2290); and polymer-supported ultrafiltration (PSU or PSUF) (Spivakov et al., (1985) Nature 315:313, Geckeler et al., (1996) Envir. Sci. Technol., 30:725, Muslehiddinoglu et al., (1998) J. Memb. Sci, 140:251, Juang et al., (1993) J. Membrane Sci. 82:163.).

Because micelles provide a compatible nanoenvironment for the partitioning of organic solutes, aqueous solutions of surfactants above their critical micelle concentration (CMC) can significantly enhance the solubility of organic pollutants in water (Diallo, M. S. (1995), Solubilization of Nonaqueous Phase Liquids and Their Mixtures In Micellar Solutions of Ethoxylated Nonionic Surfactants, PhD Dissertation, University of Michigan., Pennel, K. D, et al. (1997), Environmental Science and Technology, 31:1382, Diallo, M. S., et al. (1994), Environmental Science and Technology, 28:1829). Several investigators have evaluated the utilization of micellar surfactant solutions to remove organic pollutants from contaminated groundwater and industrial wastewater (Dunn, R. O., Jr., et al. (1985), Sep. Sci. Technol., 20:257-284, Purkait, M. K., et al., (2005), J. Membr. Sci., 250:47-59, Purkait, M. K., et al. (2005), J. Coll. Interf Sci., 285:395-402). In a typical micellar enhanced ultrafiltration (MEUF) process, a surfactant or an amphiphilic block copolymer is added to contaminated water (Dunn, R. O., Jr., et al. (1985), Sep. Sci. Technol., 20:257-284, Purkait, M. K., et al., (2005), J. Membr. Sci., 250:47-59, Purkait, M. K., et al. (2005), J. Coll. Interf. Sci., 285:395-402). The resulting aqueous micellar solution is then passed through an ultrafiltration membrane with pore sizes smaller than those of the organic laden micelles.

Micelles are non-covalently bonded aggregates, and their formation involves free energies of the order of 10RT (where R is the ideal gas constant and T is the solution temperature). Accordingly, they tend to be dynamic and flexible structures with finite lifetime (Puvvada, S. and Blankschtein, D., (1990), J. Chem. Phys., 92:3710-3724, Israelachvili, J. N. (1992), Intermolecular and Surface Forces, 2^{nd} Ed), and their solubilization capacity, size (i.e., aggregation number, micellar core volume, etc), shape (i.e., spherical versus cylindrical) and stability (i.e., aggregation versus separation) depend to large extent on solution physicochemical conditions (surfactant concentration, temperature, ionic strength, pH, etc). Separation of intact micelles from aqueous surfactant solutions by ultrafiltration therefore requires careful attention to conditions, and the application of the method to water purification under “field conditions” is correspondingly difficult.

In PEUF, a water-soluble linear polymer with strong binding affinity for the target metal ions is added to contaminated water. The resulting solution is passed through an ultrafiltration membrane (UF) with pore sizes smaller than those of the metal ion-polymer complexes.

For these reasons, retention of micelles by UF membranes is sensitive to surfactant concentration and solution physical-chemical conditions. Although the use of micellar solutions of high-molecular-weight block ABA copolymer of PEO-PPO-PEO surfactants could reduce surfactant losses to a certain extent (Richardson et al., (1999) J. Appl. Polym. Sci. 4:2290), the leakage of surfactant monomers remains a major problem in water treatment by MEUF.

Typical micelles solubilize organic solutes through partitioning into their hydrophobic core, and bind metal ions through electrostatic interactions with negatively-charged head-groups. As a result, MEUF processes are not very selective and have relatively low capacity. Moreover, the development of surfactant solutions with redox, catalytic and biocidal activity remains a major challenge. Thus, MEUF has remained for the most part a separation process with limited practical applications.

The PSUF process was designed to remove metal ions from contaminated wastewater streams. The technology uses water-soluble polymers prepared with selective receptor sites to sequester metal ions, organic molecules, and other species from dilute aqueous solutions. The water-soluble polymers are designed with a large enough molecular size that they can be separated and concentrated using ultrafiltration (UF) methods. Water and small, unbound components of the solution pass freely through the UF membrane while the polymer and its load of bound contaminants remains in the retentate. PSUF uses soluble high-mass linear polymers such as polyethyleneimine and polyacrylic acid, or polymers bearing chelating groups such as EDTA or cyclams, that exhibit chelation properties toward the metal(s) of interest. Principal drawbacks of the PSUF process are the fouling of the separation membrane by aggregated polymer, the low specificity and fixed properties of bare polyethyleneimine and polyacrylic acid, and the high cost of derivatized polymers bearing chelating moieties. As a result, practical uses of PSUF are largely limited to high-value applications, such as precious metal recovery and nuclear fuel and nuclear waste processing.

The removal of anions from water is also a process of growing importance, as anionic contaminants become more common and their effects on health become better understood.

For example, as perchlorate contamination of water supplies has become more widespread, and as water quality standards have lowered the acceptable levels of perchlorate in drinking water, the removal of perchlorate from water has become an increasingly important process. Ion exchange (IEX) is presently the method of choice, using either non-selective resins or selective resins. See Gu, B. and Brown, G. M. “Recent advances in ion exchange for perchlorate, treatment, recovery and destruction” In Perchlorate Environmental Occurrence, Interactions and Treatment, Gu, B. and Coates, J. D., Eds.; Springer: New York, 2006; see also Tripp, A. R. and Clifford. D. A. “Ion exchange for the remediation of perchlorate-contaminated drinking water” J. Am. Water Works Assn. 2006, 98:105-114.

Resin regeneration and reuse, and waste brine management and disposal, are issues that limit the efficiency, cost effectiveness and environmental acceptability of IEX processes used to ameliorate water contamination by ClO₄⁻. The non-selective resins are inexpensive, but require frequent regenerations with brine (6-12% NaCl solution) due to their low ClO₄⁻ capacity and selectivity. This generates a large volume of perchlorate-containing brine that presents disposal and waste-treatment problems of its own. The ClO₄⁻ selective resins do not require frequent regenerations, but because of their strong binding affinity for ClO₄⁻, they are not readily regenerated. In the absence of a regeneration cycle, and despite their relatively high cost, spent ClO₄⁻-selective resins are usually incinerated following a single use. Regeneration of ClO₄⁻ selective resins with concentrated acidic ferric chloride has been demonstrated, but the subsequent high-temperature treatment of the regenerant solution presents yet another set of capital expense, operating costs, and disposal problems.

Due to the ongoing demand for clean water and the limitations of the current methods, there is a significant need for a new water filtration process with a higher capacity for binding contaminants, as well as features that enable it to be scalable, flexible, and configurable to suit a variety of different water purification needs. The present invention provides methods and materials that address some of these needs.

### SUMMARY OF THE INVENTION

The invention provides improved dendrimer-assisted methods of removing one or more dissolved species (solutes) from aqueous fluids, by contacting the fluid with an amount of a dendrimer agent sufficient to bind at least a portion of the dissolved species to produce a quantity of dendrimer-bound solute, and filtering the dendrimer-bound solute from the fluid, whereby a quantity of filtered fluid with a reduced level of dissolved species is produced.

Preferred embodiments provide methods wherein the filtering process employs a filter selected from the group consisting of nanofilters, ultrafilters, microfilters, and combinations thereof. Further preferred embodiments comprise the application of pressure, vacuum, gravity, and combinations thereof to accelerate the filtration process.

Certain embodiments of the invention provide methods wherein at least one solute is copper, cobalt, nickel, lead, cadmium, zinc, mercury, iron, chromium, silver, gold, cadmium, iron, palladium, platinum, gadolinium, uranium, or arsenic, and the dendrimer is a cation-binding dendrimer that binds the ions of at least one metal selected from the group consisting of copper, cobalt, nickel, lead, cadmium, zinc, mercury, iron, chromium, silver, gold, cadmium, iron, palladium, platinum, gadolinium, uranium, and arsenic, and combinations thereof.

Other embodiments relate to methods wherein the dendrimer-bound solute is subjected to a recycling reaction to separate at least a portion of the solute from at least a portion of the dendrimer-bound solute to produce a quantity of solute and a quantity of unbound dendrimers, and further comprising re-using the unbound dendrimers in the overall process.

Another embodiment of the invention relates to a water filtration system, comprising a reaction unit including a quantity of a dendrimer agent and a filtration unit in fluid communication with the reaction unit.

Still further embodiments relate to a water filtration system comprising a dendrimer recovery unit in fluid communication with the filtration unit and configured to implement a recycling reaction to recycle a quantity of dendrimers. In the recycling reaction, the dendrimer-bound ions are released from the dendrimer agent, and the dendrimer agent thus obtained is filtered from the released ions by any of the filtration methods described herein, and re-used in the reaction unit. The filtration unit and the dendrimer recovery unit may optionally be integrated.

Certain embodiments of the invention relate to a method of binding contaminants in water, comprising providing a quantity of contaminated water, and contacting the contaminated water with a dendrimer agent.

Certain embodiments of the invention relate to the removal of an anion from water by contacting the water with at least two dendrimer agents, one of which preferentially binds to the anion. In preferred embodiments, the anion is perchlorate, which is removed from water by contacting perchlorate-containing water with a dendrimer agent having binging affinity for perchlorate ions, in the presence of one or more additional dendrimer agents having binding affinity for ions other than perchlorate. In particularly preferred embodiments, the water is contacted with at least a second dendrimer agent having binding affinity for sulfate ions.

In any of the methods and systems of the invention, the dendrimer agent may comprise a quantity of a tecto-dendrimer or linear-dendritic copolymer, and the dendrimer agent may also comprise a quantity of a dendrimer selected from the group consisting of cation-binding dendrimers, anion-binding dendrimers, organic compound-binding dendrimers, redox-active dendrimers, biological compound-binding dendrimers, catalytic dendrimers, biocidal dendrimers, viral-binding dendrimers, multi-functional dendrimers, and combinations thereof.

### BRIEF DESCRIPTION OF THE DRAWINGS

FIG. 1 shows a sample embodiment of a dendrimer-enhanced filtration system in accordance with an embodiment of the present invention.

FIG. 2 shows examples of different types of dendrimers.

FIG. 3 shows an example of a composite solid-supported filter for purification of water contaminated by mixtures of cations, anions, organic/inorganic solutes, bacteria and viruses.

FIG. 4 shows two examples of PAMAM dendrimers with EDA core and NH₂ terminal groups.

FIG. 5A shows the extent of binding of Cu(II) in aqueous solutions to EDA core G4-NH₂ PAMAM dendrimers as a function of metal ion dendrimer loading and solution pH, in accordance with an embodiment of the present invention.

FIG. 5B shows the extent of binding of Cu(II) in aqueous solutions to G4-Ac(NHCOCH₃) PAMAM dendrimers as a function of metal ion dendrimer loading and solution pH, in accordance with an embodiment of the present invention.

FIG. 6 shows the fit of a two-site model of Cu(II) uptake by G4-NH2 PAMAM dendrimer in aqueous solutions plotted against the measured extent of binding at room temperature and pH 7.0.

FIG. 7A shows the retention of EDA core G3-NH₂, G4-NH2, and G5-NH₂ PAMAM dendrimers in aqueous solutions as a function of solution pH using a regenerated cellulose membrane, in accordance with an embodiment of the present invention.

FIG. 7B shows the retention of EDA core G3-NH₂, G4-NH₂, and G5-NH₂ PAMAM dendrimers in aqueous solutions as a function of solution pH using a polyethersulfone membrane, in accordance with an embodiment of the present invention.

FIG. 8A shows Cu(II) retention in aqueous solutions of EDA core G4-NH₂ PAMAM dendrimers as a function of solution pH and molecular weight cut-off using a regenerated cellulose membrane, in accordance with an embodiment of the present invention.

FIG. 8B shows Cu(II) retention in aqueous solutions of EDA core G4-NH₂ PAMAM dendrimers as a function of solution pH and molecular weight cut-off using a polyethersulfone membrane, in accordance with an embodiment of the present invention.

FIG. 8C shows Cu(II) retention in aqueous solutions of EDA core G3-NH₂, G4-NH₂, and G5-NH₂ PAMAM dendrimers as a function of dendrimer type and membrane chemistry, in accordance with an embodiment of the present invention.

FIG. 9A shows the permeate flux in aqueous solutions of Cu(II)+EDA Core G4-NH₂ PAMAM at pH 7, with a 10 kD cut-off regenerated cellulose membrane, in accordance with an embodiment of the present invention.

FIG. 9B shows the permeate flux in aqueous solutions of Cu(II)+EDA Core G4-NH₂ PAMAM dendrimer as a function of solution pH and molecular weight cut-off with a regenerated cellulose membrane, in accordance with an embodiment of the present invention.

FIG. 9C shows the permeate flux in aqueous solutions of Cu(II)+EDA Core G4-NH₂ PAMAM dendrimer as a function of solution pH and molecular weight cut-off with a polyethersulfone membrane, in accordance with an embodiment of the present invention.

FIG. 9D shows the permeate flux in aqueous solutions of Cu(II)+EDA Core G3-NH₂, G4-NH₂, and G5-NH₂ PAMAM dendrimers at pH 7 with a polyethersulfone membrane, in accordance with an embodiment of the present invention.

FIG. 10A shows normalized permeate flux in aqueous solutions of Cu(II)+EDA core G4-NH₂ PAMAM dendrimer as a function of solution pH and molecular weight cut-off with a regenerated cellulose membrane, in accordance with an embodiment of the present invention.

FIG. 10B shows normalized permeate flux in aqueous solutions of Cu(II)+EDA core G3-NH₂, G4-NH₂, and G5-NH₂ PAMAM dendrimers at pH 7 with a 10 kD molecular weight cut-off regenerated cellulose membrane, in accordance with an embodiment of the present invention.

FIG. 10C shows normalized permeate flux in aqueous solutions of Cu(II)+EDA core G4-NH₂ PAMAM dendrimers as a function of solution pH and molecular weight cut-off with a polyethersulfone membrane, in accordance with an embodiment of the present invention.

FIG. 10D shows normalized permeate flux in aqueous solutions of Cu(II)+EDA core G3-NH₂, G4-NH₂, and G5-NH₂ PAMAM dendrimers at pH 7 with a 10 kD molecular weight cut-off polyethersulfone membrane in accordance with an embodiment of the present invention.

FIG. 11 shows the extent of binding of Co(II) in aqueous solutions of EDA core G4-NH₂ PAMAM dendrimer at room temperature as function of solution pH and metal ion dendrimer loading, in accordance with an embodiment of the present invention.

FIG. 12 shows the extent of binding of Ag(I) in aqueous solutions of EDA core G4-NH₂ PAMAM dendrimer at room temperature as function of solution pH and metal ion dendrimer loading, in accordance with an embodiment of the present invention.

FIG. 13 shows the extent of binding of Fe(III) in aqueous solutions of EDA core G4-NH₂ PAMAM dendrimer at room temperature as function of solution pH and metal ion dendrimer loading, in accordance with an embodiment of the present invention.

FIG. 14 shows the extent of binding of Ni(II) in aqueous solutions of EDA core G4-NH₂ PAMAM dendrimer at room temperature as function of solution pH and metal ion dendrimer loading, in accordance with an embodiment of the present invention.

FIG. 15 shows the extent of binding of perchlorate in aqueous solutions of G5-NH₂ DAB core PPI dendrimer, in accordance with an embodiment of the present invention.

FIG. 16 shows the effect of pH on the extent of binding of perchlorate to G5-NH2 PPI dendrimer in deionized water at an initial perchlorate concentration of 1000 ppb (0.01 mM).

FIG. 17 shows the effect of pH on the fractional binding of perchlorate to G5-NH2 PPI dendrimer in deionized water at an initial perchlorate concentration of 1000 ppb (0.01 mM).

FIG. 18 compares the extent of binding of perchlorate to G5-NH2 PPI and G4-NH2 PAMAM dendrimers at an initial perchlorate concentration of 1000 ppb (0.01 mM).

FIG. 19 compares the extent of binding of 1000 ppb perchlorate to G5-NH2 PPI dendrimer in deionized water and model electrolyte solutions. Electrolyte 1 contains 0.1 mM NaCl, 0.3 mM NaHCO3, 0.1 mM NaNO3 and 0.1 mM Na2SO4; Electrolyte 2 contains 1.0 mM NaCl, 3.0 mM NaHCO3, 1.0 mM NaNO3 and 1.0 mM Na2SO4.

FIG. 20 shows the effect of added G4-NH2 PAMAM dendrimer on the extent of binding of 1000 ppb perchlorate to G5-NH2 PPI dendrimer in deionized water and in model electrolyte.

FIG. 21 shows the extent of binding of 1000 ppb perchlorate to G5-NH2 PPI dendrimer in deionized water and model electrolyte solution as measured at 1, 4, and 24 hours.

FIG. 22A shows the extent of binding of Fe(III) in aqueous solutions of EDA core G4-NH₂ PAMAM dendrimer at room temperature and pH=7.0, in accordance with an embodiment of the present invention.

FIG. 22B shows the fractional binding of Fe(III) in aqueous solutions of EDA core G4-NH₂ PAMAM dendrimer at room temperature and pH=7.0, in accordance with an embodiment of the present invention.

FIG. 23A shows the reductive dehalogenation of perchloroethylene in aqueous solutions of Fe(0) EDA core G4-NH₂ PAMAM dendrimer nanocomposites in accordance with an embodiment of the present invention. The diamonds represent the amounts of perchloroethylene, and the squares represent the amounts of trichloroethylene.

FIG. 23B shows the reductive dehalogenation of perchloroethylene in aqueous solutions with Fe(0) in the absence of EDA core G4-NH₂ PAMAM dendrimers, in accordance with an embodiment of the present invention. The diamonds represent the amounts of perchloroethylene, and the squares represent the amounts of trichloroethylene.

### DETAILED DESCRIPTION OF THE INVENTION

The invention disclosed herein relates generally to materials and methods for the removal of solutes from aqueous fluids. In particularly useful embodiments, the materials and methods of the invention are useful for the removal of contaminants from water. For that reason, the invention will be discussed for the most part in terms of water and contaminants, but it should be understood that the materials and methods of the invention are not limited to those particular embodiments but are applicable to other fluids and solutes. For the purposes of this description, suspended nanoscale particles, such as bacteria and viruses, are considered to be “solutes”.

The methods of the invention are useful for removing the cations and ate-complex anions of metals, including but not limited to cobalt, nickel, lead, cadmium, zinc, mercury, iron, chromium, silver, gold, cadmium, iron, palladium, platinum, gadolinium, uranium, and arsenic. Cations may be of any oxidation state commonly found in groundwater or industrial waste streams. The term “ate-complex anions” refers to water-soluble complex anions, such as chloridate ions and oxyanions, of the formula MXₙ^{-m}, where each X is independently oxygen, nitrate, cyanide, carboxylate, or halogen, n is 1-6, and the negative charge m ranges from 1 to 6. Examples include, but are not limited to, arsenate, uranyl, chloroaurate, and chloroplatinate ions.

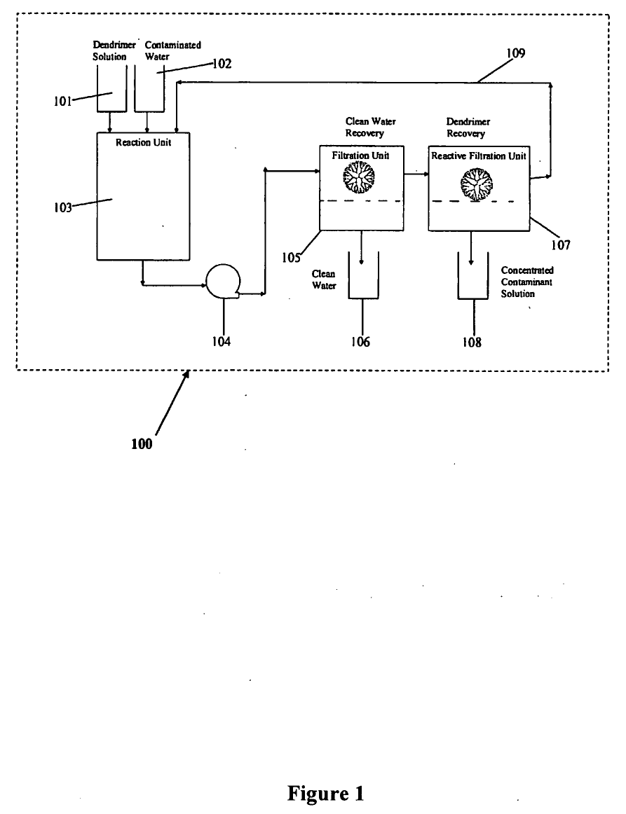

The key process, referred to as “dendrimer-enhanced filtration” (DEF), uses dendritic macromolecules, or dendrimers, and a filtration step to produce a filtered fluid. The DEF process, as shown in FIG. 1, is structured around three unit operations: a reaction unit, a filtration unit, and a dendrimer recovery unit. In the reaction unit (103), the contaminated water or other fluid (102) is mixed with a solution of functionalized dendritic polymers (101) to carry out any of a number of specific reactions of interest, including metal ion chelation, organic compound solubilization, contaminant oxidation-reduction, contaminant hydrolysis, binding of anions, and microbial/viral disinfection. Following completion of the binding of the contaminants and/or the reaction, the resulting solution is passed through a filter in the filtration unit (105), producing a quantity of treated fluid (106). A pump, (104) or a plurality of pumps (not shown), may be used at a number of different stages of the process to promote flow of the reaction components to various regions of the system. The contaminant laden dendrimer solutions are subsequently sent to an optional dendrimer recovery unit (107), where the dendritic polymers, and if desired, the contaminants that were bound to the dendrimers (108), are recovered. The recycled dendrimers may be recycled back into the reaction unit (109). The recovered contaminants may be otherwise disposed of or utilized. The term “system” (100) refers to the overall DEF process, which may have any number or combination of some or all of the components described above or hereafter.

Dendrimers are particularly useful molecules for this purpose. Unlike micellar surfactant solutions, aqueous solutions of dendritic polymers contain globular nanostructures that are held together by covalent bonds. Because of their monodispersity and stable globular shape over a broad range of solution pH and background electrolyte concentration, the leakage of dendritic polymers through filtration membranes with an appropriate molecular weight cut-off (MWCO) is highly improbable. Dendritic polymers also have much less tendency to pass through filtration membranes than linear polymers of similar molar mass because of their much lower polydispersity and persistent globular shape. In particular, unlike a linear polymer, a dendrimer molecule cannot adopt an extended conformation and snake through the pores of a membrane.

Whereas the intrinsic viscosity of a linear polymer increases with its molar mass, that of a dendrimer decreases as it adopts a molar globular shape at higher generations (Fréchet and Tomalia, (2001) Dendrimers and other Dendritic Polymers; John Wiley and Sons). Because of this, dendrimers have a much smaller intrinsic viscosity than linear polymers with similar molar mass. Thus, comparatively smaller operating pressure, energy consumption and loss of ligands by shear-induced mechanical breakdown can be achieved with dendrimers in tangential/cross-flow pressure driven filtration systems typically used in water purification. Dendritic polymers can be designed to incorporate a wide variety of different functional groups that facilitate binding and/or reaction with a wide range of different type of contaminants. Table 1 shows some examples of different types of dendrimer reactive groups and their target contaminants; this list is by no means exhaustive.

TABLE 1
Dendrimer Active Groups, Target Contaminants, and Recycling System

| Active Groups | Target Contaminants |
|---|---|
| Amines, Hydroxyl, Carboxyl, TRIS, | Ag(I), Au(I) |
| Succinamic acid, Carbomethoxy pyrrolidinone, | Cu(II), Ni(II), |
| Oxalate, Imidazole and other N, O, P and S | Co(II), Pd(II), |
| containing dendrimer terminal and internal | Pt(II), Mn(II) Fe(III), Co(III), Gd(III), U(VI), |
| groups. | etc |
| Transition metal ions, Redox active organic | Water-soluble reactive organic and inorganic |
| groups, Catalytic organic groups, etc. | compounds, redox active metal ions, anions, |
| | organic and inorganic solutes, etc. |
| Complexes with transition metal ions (Ag(I), | Bacteria |
| Cu(II), etc), Bioactive organic groups | Viruses, etc |
| Hydrophobic core | Water soluble organic solutes |
| Hydrophobic shell | |
| Alkyl amines, Trialkyl amines, Amide NH | Water soluble anions |
| groups, Pyrrole NH groups, Quaternary | |
| ammonium chlorides, Complexes with transition | |
| metal ions (e.g., Cu(II)) | |

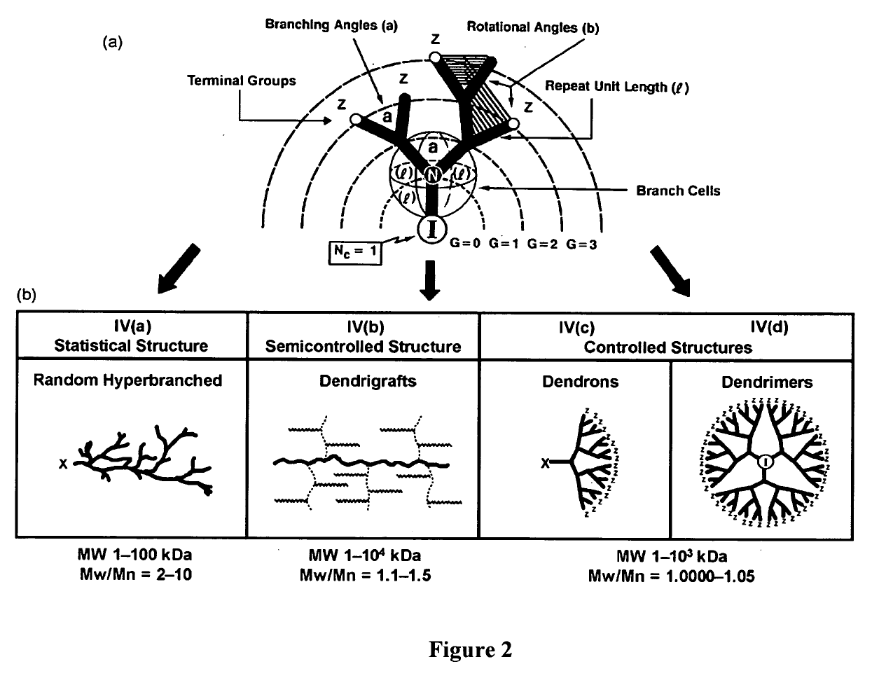

The term “dendrimer”, or “dendritic macromolecule”, refers to 3-D globular macromolecules that may have three covalently bonded components: a core, interior branch cells and terminal branch cells. For the purpose of this application, dendrimers include hyperbranched polymers, dendrigraft polymers, tecto-dendrimers, core-shell(tecto)dendrimers, hybrid linear-dendritic copolymers, dendronized polymers, dendrimer-based supramolecular assemblies and dendrimer-functionalized solid particles. FIG. 2 shows some examples of different types of dendrimers. They may be functionalized with surface groups that make them soluble in appropriate media or facilitate their attachment to appropriate surfaces. They may be bioactive dendrimers, as later defined herein.

The term “dendrimer agent” refers to a chemical composition containing dendrimers. The dendrimer agent may comprise a single dendrimer with a single functionality, a single dendrimer with multiple functionalities, a mixture of dendrimers, dendrimers that have been cross-linked to other dendrimers (tecto-dendrimers, or megamers), and dendrimers that have been covalently linked to linear polymers to produce linear-dendritic copolymers or dendronized linear polymers.

A dendrimer agent may also include buffers, salts, stabilizers or inert ingredients, and may be provided in a number of forms, including but not limited to solids, solutions, suspensions, gels, semi-liquids, and slurries. As will be recognized by one of skill in the art, there is a variety of different dendrimer agent compositions that would be suitable for the system and would therefore fall within the scope of the present invention.

One suitable type of dendrimer is a poly(amidoamine) (PAMAM) dendrimer with an ethylene diamine (EDA) core. PAMAM dendrimers possess functional nitrogen and amide groups arranged in regular “branched upon branched” patterns which are displayed in geometrically progressive numbers as a function of generation level (FIG. 2). The high density of nitrogen ligands enclosed within a nanoscale container makes PAMAM dendrimers particularly attractive as high capacity chelating agents for metal ions in aqueous solutions.

Commercially available PAMAM dendrimers may be used to develop efficient, cost effective and environmentally-acceptable chelating agents for removing arsenic, cadmium, chromium, copper, lead, mercury and fluoride ion from contaminated water. To this end, NH₂-terminated G3, G4 and G5 PAMAM dendrimers with an ethylene diamine (EDA) core may be reacted with the appropriate reagents to build PAMAM dendrimers with various terminal groups that are optimizable and have binding specificities that target toxic metal ions and inorganic contaminants. The dendrimer terminal groups may include hydroxide, acetamide, carboxylate, phosphonate, sulfonate and quaternary amine (methyl). In all cases, the chemical compositions of the surface modified dendrimers may be monitored by FTIR/¹³C NMR spectroscopy and size exclusion chromatography. The molar masses of the surface modified PAMAM dendrimers may be determined by matrix assisted laser desorption (MALDI)-time of flight (TOF) mass spectrometry (MS) and gel electrophoresis.

A system for carrying out the process of DEF may comprise a number of different components or units. The term “reaction unit” refers to a component of a water filtration system where dendrimers and contaminated water are mixed. The reaction unit may contain a single type of dendrimer, or a mixture of different types of dendrimers, as well as multifunctional dendrimers. In some cases, the dendrimers and the contaminated water undergo a reaction, such as binding or catalysis, and the reaction unit may be subjected to conditions that facilitate a such a reaction. Such conditions include but are not limited to elevated or reduced temperature and elevated or reduced pH.

As used herein, the term “contaminated water” refers to water that contains at least one solute which the practitioner desires to separate from the water. The value to the practitioner may lie in the purified water, in the separated solute, or both. Thus, such solutes may, for example, comprise a substance, the presence of which renders the water unfit for consumption, use in an industrial process, or disposal into a waterway. Such solutes may also comprise a substance that is of commercial value when isolated from solution, such as a metal present in an industrial waste water stream or in a solution-mining leachate or lixiviant fluid. Possible substances include but are by no means limited to metal ions, anions, organic compounds, bacteria, viruses, and biological compounds such as proteins, carbohydrates, and nucleic acids. Contaminants are often toxic metals and chemicals found in the environment that need to be removed from water in order to make it potable. Examples of toxic compounds that may be removed or treated by a DEF system include, without limitation, copper, perchloroethylene, perchlorate, arsenic (arsenite and arsenate), chromium (chromate), and lead. The term “treated” or “filtered” water refers to water from which at least one contaminant has been removed or catalytically modified.

The term “filtration unit” refers to a component of a water filtration system wherein contaminated water that has been contacted with a dendrimer agent is filtered such that water and free solutes pass through a filter, but dendrimers and dendrimers with bound solutes are retained. It may also be referred to as a “clean water recovery unit”. The filter in the filtration unit is referred to as the “filtration unit filter”. The solution that passes through the membrane is referred to as the “filtrate”. The goal of the filtration unit is to produce “clean” water; water from which a measurable, and preferably a substantial amount of at least one contaminant have been removed by the dendrimers. It is within the scope of the application to have the reaction unit integrated with the filtration unit. As used herein, the term “integrated” refers to multiple components that are mechanically interconnected such as in a single physical unit.

The term “filter” refers to an entity that is often a physical barrier, that retains some molecules or compounds while allowing others to pass through. In most cases, the selection of what passes through the filter is based on size; for example, a filter retains larger compounds and molecules while allowing smaller ones to pass through. An example of a simple size-based filter is a porous membrane. Membrane-based systems may be suitable for use in DEF, as a membrane may be used that has a smaller pore size than the dendrimers, so that dendrimers and any dendrimer-bound contaminants are retained by the membrane, while water from which the contaminants have been removed passes through as a filtrate.

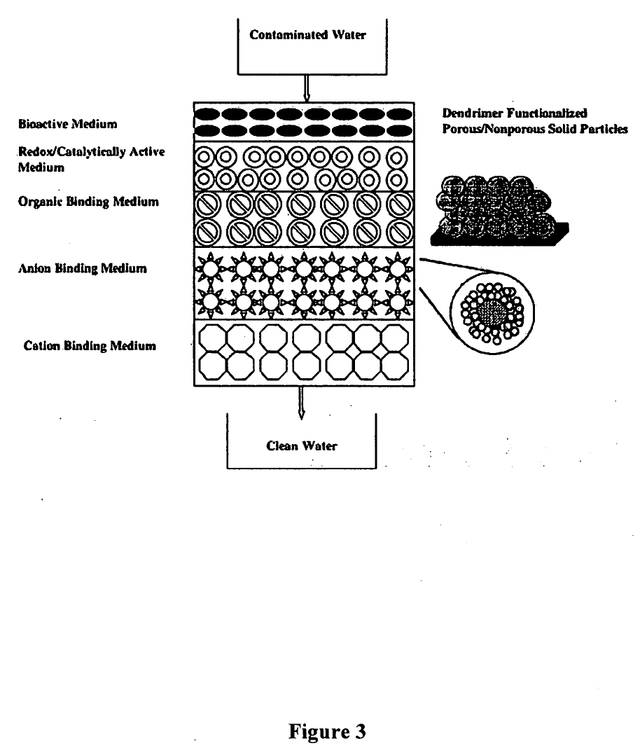

An alternative type of filter is one in which the filtering entity is in contact with a solid support or matrix. In this situation, dendrimers may be attached to or deposited on a surface of a solid matrix. For example, with PAMAM dendrimers, the chemistry of the terminal groups may be used to either covalently or non-covalently attach the dendrimers to a solid support. Contaminated water is provided to the dendrimer/matrix assembly, and binding of the contaminants to the dendrimer occurs. Water from which at least a portion of the contaminants have been removed is produced. Solid-supported filters may include a number of different dendrimers and dendrimer types, including but in no way limited to cation/anion selective ligands, redox active metal ions and clusters, catalytically active metal ions and clusters, hydrophobic cavities, and bioactive agents. An example of a solid-supported filter is shown in FIG. 3.

Thus, the term “filter” encompasses but is not limited to membranes and solid-support filters. It is also possible that a system has both a membrane filter and a solid supported filter in the same unit, or in separate units operated in parallel or in series.

The filtration process, which separates the free dendrimers and contaminant-bound dendrimers from the filtered water, may be driven by pressure, vacuum, or gravity. If pressure is used, it may be applied to the side of the membrane containing the dendrimers to increase the flow of filtrate through the membrane. Pressure may be generated by the application of gas pressure, or may be mechanically applied, for example by pistons or by the action of a centrifuge. A vacuum may be applied to the side of the membrane opposite of the dendrimer-containing side, to increase the flow rate from the other side of the membrane. Filtration may also be driven by the hydrostatic pressure provided by gravity, and combinations of applied pressure, vacuum, and hydrostatic pressure may be used.

The pore size of the filter may vary, and will be appropriate to the size and type of the dendrimers used in the system. Examples of suitable filters are nanofilters, used for nanofiltration (NF), ultrafilters, used for ultrafiltration (UF), and microfilters, used for microfiltration (MF). Nanofilters may have a pore size that is less than about 2 nanometers (nm) in diameter. Ultrafilters may have a pore size ranging from about 2 to 20 nm, which may be useful for non-cross-linked dendrimers. Microfilters may have membranes with pores larger than 20 nm, which may be particularly useful for retaining cross-linked dendrimers (tecto-dendrimers) or megamers. In general, the larger pore size of MF membranes allow a faster flow rates than the UF and NF membranes.

The “dendrimer recovery unit” or “recycling unit” is a component of a water filtration system wherein at least a portion of the solutes that were bound to dendrimers earlier in the process are separated from the dendrimers, producing a quantity of unbound dendrimers and a quantity of solutes. Following removal of the solutes from the dendrimers, the dendrimers may be re-used in future rounds of water filtration. The removed solutes may be discarded in a waste stream, or isolated to the degree required for safe disposal or for use as a resource.

The term “recycling reaction” refers to any process by which contaminant-bound dendrimers are recycled, recovered, regenerated, or otherwise returned to a state that is useful for binding contaminants. In cases where the binding capacity of the dendrimers exceeds the amount of contaminants in the solution, thereby leaving a portion of dendrimers un-bound following the reaction unit step, the un-bound dendrimers may be subjected to a recycling reaction along with the contaminant-bound dendrimers. The type of recycling reaction used depends on the nature of the interaction between the contaminant and the dendrimer. Recycling processes suitable for various dendrimer types are described below; although one of skill in the art will readily recognize a number of variations and additional processes that may be readily implemented, and are considered to be within the scope of the present invention. The recycling reaction may take place in the dendrimer recovery unit, or in an integrated system, such as one where the filtration unit and the dendrimer recovery unit share the same membrane or filter.

In many cases, it is useful to formulate mixtures of dendritic polymers with different functionalities to treat water contaminated by multicomponent mixtures of chemical and biological contaminants. In cases where multi-component dendrimer agents are used, it may be desirable to have multiple dendrimer recovery units, although this is not required. If multiple dendrimer recovery units are used, they may be configured in series or in parallel.

In some cases, it may not be possible or desirable to recycle the dendrimers. For example, if the compounds that are bound in the dendrimers in the reaction unit are radioactive, or pose some other sort of environmental hazard, it may be desirable for the contaminant-bound dendrimers to be used once and then processed as waste.

It is also possible and well within the scope of the present invention to have systems wherein the filtration unit and the dendrimer recovery unit are integrated, or are a single unit. In the case of a membrane filter, a single membrane may used in both processes. In the case of a solid-support filter, the same unit may be subjected to different conditions to promote either retention or recovery of contaminants.

There are many types of water treatment processes, and within these treatment processes, there are many stages where it is desirable to remove specific contaminants from water. The US Environmental Protection Agency is evaluating a number of alternative water purification systems for small communities (US EPA (1998) Office of Water Report EPA 815-R-98-002). These include package treatment plants (i.e., factory assembled compact and ready to use water treatment systems), point-of-entry (POE) and point-of-use (POU) treatment units designed to process small amounts of water entering a given unit (e.g., building, office, household, etc) or a specific tap/faucet within the unit. The DEF processes and systems comprising the inventive DEF methods are readily adaptable for these types of water treatment systems.

DEF processes and systems have the potential to be flexible, reconfigurable, and scalable. The process is scalable; it is limited only by very few factors (e.g., by the size of or number of filters or membranes) as will be readily appreciated by those of skill in the art. The flexibility of DEF is illustrated by its adaptability to a modular design approach. DEF systems may be designed to be “hardware invariant” and thus reconfigurable in most cases by simply changing the dendrimer agent and dendrimer recovery system for the targeted contaminants. Thus, DEF may be used in small mobile membrane-based water treatment systems as well as larger and fixed treatment systems and a host of other commercial, residential, and industrial applications. Dendrimer-enhanced filtration is a useful tool for removing cations from aqueous solutions, particularly metal ions. DEF has been shown to be more effective than polymer- supported ultrafiltration (PSUF) at recovering metal ions such as Cu(II) from contaminated water (Diallo, M. S. et al. (2005), Envir. Sci. Technol., 39: 1366-1377).

Metal ion complexation is an acid-base reaction that depends on several parameters including (i) metal ion size and acidity, (ii) ligand basicity and molecular architecture and (iii) solution physical-chemical conditions. Three important aspects of coordination chemistry are the Hard and Soft Acids and Bases (HSAB) principle, the chelate effect and the macrocyclic effect (Martell and Hancock, (1996) Metal Complexes in Aqueous Solutions; Plenum Press: New York.). The HSAB principle provides “rules of thumb” for selecting an effective ligand (i.e., Lewis base) for a given metal ion (i.e., Lewis acid). Table 2 shows the binding constants of metal ions to selected unidendate ligands. The OH⁻ ligand is representative of ligands with negatively charged “hard” O donors such as carboxylate, phenolate, hydroxamate, etc. Conversely, NH₃ is representative of ligands with “hard” saturated N donors (e.g. aliphatic amines); whereas imidazole is representative of “border line” hard/soft ligands with unsaturated N donors. Mercaptoethanol (HOCH₂CH₂SH), on the other hand, is representative of ligands with “soft” S donors such as thiols.

TABLE 2
Binding Constants of Selected Metal Ions to Unidendate Ligands

| Metal | log K₁ | log K₁ | log K₁ | log K₁ |
|---|---|---|---|---|
| Ion | (OH⁻) | (NH₃) | (Imidazole) | HOCH₂CH₂S⁻ |
| Cu(II) | 6.30 | 4.04 | 3.76 | 8.10 |
| Co(II) | 3.90 | 2.10 | 1.63 | 3.06 |
| Ni(II) | 4.10 | 2.70 | 1.92 | 3.14 |
| Pb(II) | 6.30 | 1.60 | 2.04 | 5.71 |
| Cd(II) | 3.9 | 2.55 | 2.54 | 7.45 |
| Zn(II) | 5.00 | 2.21 | 1.86 | 3.19 |
| Hg(II) | 10.60 | 8.8 | 8.68 | 27.21 |
| Fe(II) | 3.60 | 1.4 | 1.41 | 2.9176 |
| Fe(III) | 11.81 | 3.8 | 3.51 | 8.5885 |
| Cr(III) | 10.07 | 3.40 | 3.05 | 7.3741 |
| Ag(I) | 2.00 | 3.30 | 3.43 | 11.3369 |
| Au(I) | 2.70 | 5.6 | 5.63 | 18.769 |
| Na(I) | −0.20 | −1.1 | −1.50 | −4.72 |
| Mg(II) | 2.58 | 0.23 | −0.01 | −1.42 |
| Ca(II) | 1.30 | −0.2 | 0.06 | −0.07 |

Consistent with the HSAB principle, Table 2 shows that soft metal ions such Hg(II) and Au(I) tend to form more stable complexes with ligands containing S donors. Conversely, hard metal ions such Fe(III) tend to prefer hard ligands with O donors; whereas borderline hard/soft metal ions such as Cu(II) can bind with soft/hard ligands containing N, O and S donors depending on their specific affinity toward the ligands.

The chelate effect is predicated upon the fact that metal ions form thermodynamically more stable complexes with ligands containing many donor atoms than with unidentate ligands. Conversely, the macrocyclic effect highlights the fact that metal ions tend to form thermodynamically more stable complexes with ligands containing pre-organized cavities lined with donors (i.e., Lewis bases) than with multidendate and unidentate ligands (Martell and Hancock, (1996) Metal Complexes in Aqueous Solutions; Plenum Press: New York.).

Dendritic macromolecules provide ligand architecture and coordination chemistry for metal chelation. Although macrocyles and their open chain analogues (unidentate and polydentate ligands) form stable complexes with a variety of metal ions, their limited binding capacity (1:1 complexes in most cases) is a major impediment to their utilization as high capacity chelating agents for environmental separations such as water purification. Their relatively low molecular weights also preclude their effective recovery from wastewater by low cost membrane-based techniques (e.g., ultrafiltration and nanofiltration). During the last 10 years, substantial research efforts have been devoted to the evaluation of the commercially available poly(amidoamine) (PAMAM) dendrimers from Dendritic Nanotechnologies (DNT) and Dendritech, and the ASTRAMOL™ poly(propyleneimine) imines (PPI) dendrimers from DSM as high capacity chelating agents, metal ion contrast agent carriers for magnetic resonance imaging, and templates for the synthesis of metal-bearing nanoparticles with electronic, optical, biological, and catalytic activities. These studies provide key data and insight into the selection of water soluble and recyclable dendrimers with high binding capacity and selectivity toward a broad range of metal ions including Cu(II), Ni(II), Co(II), Pd(II), Pt(II), Zn(II), Fe(III), Co(III), Gd(III), U(VI), Ag(I), Au(I), etc.

Other dendritic polymers that could be used as metal ion chelating agents include water-soluble phosphorous dendrimers (e.g., as disclosed by Dozol et al., PCT international application WO 2004/076509), and the HYBRANE™ polyester amide hyperbranched polymers available from DSM (Heerlen, N L). Also applicable to the present invention is the recent development of a “click chemistry” route for the synthesis of low cost Priostar™ dendrimers by DNT. According to DNT, this will allow the introduction and control of six critical nanostructure design parameters that may be used to engineer over 50,000 different major variations of sizes, compositions, surface functionalities and interior nanocontainer spaces. In addition, Priostar™ dendrimers may provide a broad range of low-cost and high capacity/selectivity recyclable dendritic chelating agents for water purification; they are suitable for use in connection with alternate embodiments of the present invention and are thus considered to be within the scope thereof. Table 3 provides a list of some, but not all, commercially available dendritic polymers that may be used as high capacity and recyclable chelating agents for water purification by dendrimer-enhanced filtration in accordance with various embodiments of the present inventions.

TABLE 3
Commercially available dendritic polymers that may be used
as high capacity and recyclable chelating agents for water
purification by dendrimer enhanced filtration (DEF).

| Dendrimer | Manufacturer | Reactive Groups | Metal Ions |
|---|---|---|---|
| PAMAM | Dendritic Nano | Amino, hydroxyl, | Ag(I), Au(I) |
| dendrimers | Technologies | carboxyl, TRIS, | Cu(II), Ni(II), |
| | (DNT); | succinamic acid, | Co(II), Pd(II), |
| | Dendritech | etc. | Pt(II), Mn(II) |
| | USA | | Fe(III), Co(III), |
| | | | Gd(III), U(VI), etc |
| ASTRAMOL | DSM | amino, hydroxyl, | Ag(I), Cu(II), |
| PPI dendrimers | Netherlands | carboxyl, etc | Ni(II), Co(II), |
| | | | Fe(III), Gd(III), |
| | | | etc. |
| Priostar | Dendritic Nano | amino, hydroxyl, | Ag(I), Au(I) |
| Dendrimers | Technologies | carboxyl, ethers, | Cu(II), Ni(II), |
| | (DNT) | esters, thiol, | Co(II), Pd(II), |
| | | imidazole, etc. | Cd(II), Hg(II) |
| | | | Pt(II), Zn(II) Fe(II), |
| | | | Pb(II), Fe(III), |
| | | | Co(III), Gd(III), |
| | | | Cr(III), Cr(VI). |
| | | | As(III), As(V), |
| | | | U(VI), etc |

While a number of suitable recycling reactions may be effective at regenerating metal ion-binding dendrimers, preferred embodiments at present employ protonation of amine-based dendrimer ligands by lowering the pH.

Dendritic macromolecules can serve as stable and covalently-bonded micelle mimics, having hydrophobic interiors that can encapsulate organic solutes in aqueous and non-aqueous solutions (Zeng F. and Zimmerman, S. (1997), Chem. Rev., 1681, Bosman, A. W., et al. (1999), Chem. Rev., 99:1665, Tomalia, D. A., et al. PNAS, 99:5081-5087). Dendritic macromolecules such as PAMAM dendrimers can also solubilize organic compounds through specific interactions with their amino groups. Kleinman et al. (Kleinman, M. H., et al. (2000), J. Phys. Chem., B 104:11472-11479) have shown that 2-naphthol binds preferentially to the tertiary amine groups within the dendrimer interior. More recently, Caminade and Majoral (Caminade, A. M. and Majoral, J. P. (2005), Progr. Polym. Sci., 30:491-505) have described the preparation of water-soluble phosphorous dendrimers that can bind organic solutes. These results show that dendritic macromolecules may be used as micelle mimics that are useful for recovering organic solutes from aqueous solutions by dendrimer enhanced filtration (DEF).

A number of different dendrimer agents may be suitable for use in a DEF system that is configured to remove organic solutes from aqueous solution. Table 4 lists some manufacturers that produce dendrimers that may be used. Dendrimers that are useful in this system may have a hydrophobic core, or hydrophobic exterior, as well as a hydrophilic core or a hydrophilic exterior. The uptake of organic solutes by dendritic macromolecules in aqueous solutions may occur through several mechanisms including: 1. hydrophobic partitioning into the micellar core/shell, 2. hydrogen bonding to the macromolecule internal and terminal groups and 3. specific interactions with the macromolecule internal and terminal groups.

The recycling reaction for organic compound-binding may vary according to how the compounds are bound to the dendrimer. Some possible recycling processes include but are not limited to 1) air stripping or vacuum extraction of the bound organic solutes, 2) pervaporation of the bound organic solutes, 3) release of the bound organic solutes by protonation or deprotonation of the dendritic micelle mimics followed by UF or NF and 4) extraction of the bound organic solutes using a solvent.

TABLE 4
Commercially available dendritic macromolecules that
may be used as dendritic micelle mimics for water purification
by dendrimer enhanced filtration (DEF).

| Macromolecule | Manufacturer |
|---|---|
| PAMAM dendrimers | Dendritic Nano Technologies |
| | Dendritech |
| | USA |
| ASTRAMOL ™ PPI dendrimers | DSM |
| | Netherlands |
| PAMAMOS-TMOS dendrimers | Dendritech |
| | USA |
| Priostar ™ Dendrimers | Dendritic Nano Technologies |
| | USA |
| HYBRANE ™ Hyperbranched Polymers | DSM |
| | Netherlands |
| BOLTORN ™ Dendritic Polymers | Perstorp |
| | Sweden |

The present invention provides an alternative to ion exchange resins for the treatment of ClO₄⁻ contaminated water. The method of the invention combines functionalized ClO₄⁻-binding dendritic nanomaterials with membrane-based separation technologies such as ultrafiltration (UF). For example, the G5-NH2 PPI dendrimer has a molar a molar mass of 7168 Da and a hydrodynamic radius (Rₕ) of 1.98 nm, and can be effectively separated from aqueous solutions by UF. The maximum EOB of ClO₄⁻ to G5-NH₂ PPI dendrimer in aqueous solutions at pH 4.0 is ˜9.0; this corresponds to a binding capacity of 125 mg of ClO₄⁻ per g of dendrimer. By contrast, at an equilibrium concentration of ClO₄⁻ in water of 200 ppb, the sorption capacity for ClO₄⁻ of a typical non-selective quaternary ammonium anion-exchange resin is <1.0 mg/g, while that of a selective bifunctional polystyrene resin with ethyl/hexyl ammonium groups is about 75 mg/g.

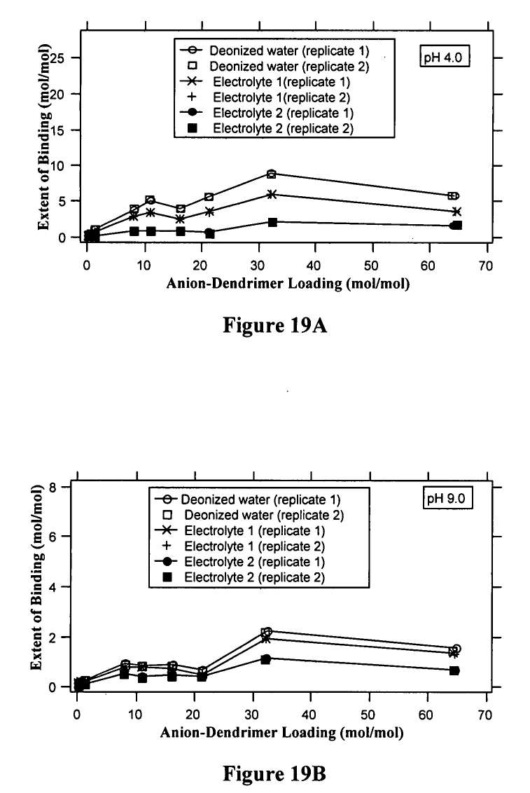

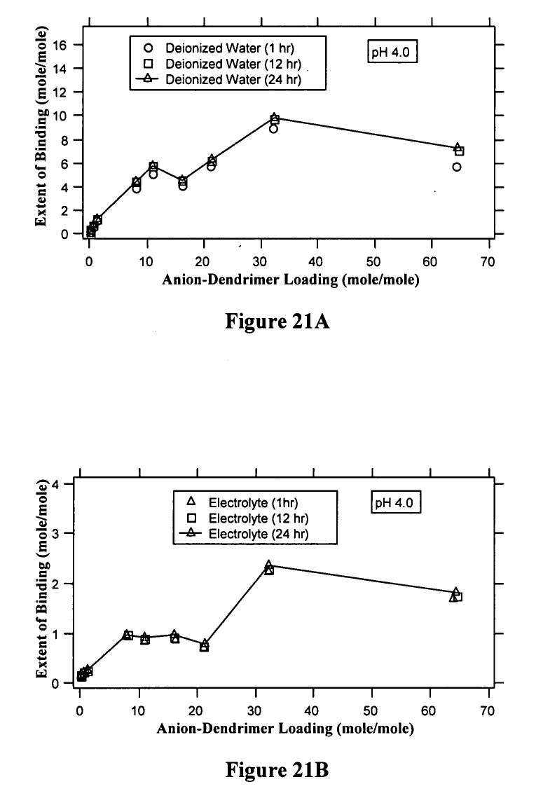

It is known that the presence of competing anions, particularly SO₄²⁻, limits the efficiency and longevity of IEX resins used to recover perchlorate from contaminated water, and S₄²⁻ can likewise reduce the perchlorate binding capacity of the G5-NH2 PPI dendrimer (FIG. 19). However, the present inventor has found that addition of a more hydrophilic dendrimer, such a G4-NH₂ PAMAM dendrimer, can suppress the effect of SO₄²⁻ anions on the ClO₄⁻ binding of the G5-NH₂ PPI dendrimer in electrolytes (FIG. 21). Accordingly, the invention also provides a method for removal of perchlorate from water containing interfering ions such as sulfate, by contacting the water with a mixture of two or more dendrimers. In these embodiments of the invention, at least one dendrimer has an affinity for perchlorate, while each additional dendrimer has an affinity for at least one interfering ion. This method may be used to effectively recover perchlorate from aqueous solutions containing high concentrations of interfering anions such as SO₄²⁻.

The method of the invention is amenable to recycling and re-use, because at pH 9.0 to 11.0 there is rapid and nearly complete release of ClO₄⁻ from the G5-NH₂ PPI dendrimer. This is a significant improvement over the use of ClO₄⁻-selective ion exchange resins, which are not readily regenerated.

Dendrimers in a dendrimer-enhanced filtration system may also be used to facilitate oxidations, reductions, or other chemical transformations of contaminants in water. Pollutants in groundwater include chlorinated alkenes such as perchloroethylene (PCE), polynitroaromatics such as trinitrotoluene (TNT), and redox active metals and anions such as Cr(VI) and NO₃. Most of these compounds may undergo catalytic reductive and oxidative transformations in aqueous solutions, which presents opportunities for remediation based on catalysis of such transformations.

Functionalized dendrimers that promote such transformations may be used as reactive media for remediation of groundwater and surface water contaminated by organic and inorganic solutes. As used herein, the term “redox” refers to chemical reactions that involve the loss or gain of one or more electrons by a molecule or ion.

A number of redox-active dendritic catalysts have been synthesized and characterized that would be useful in a DEF water filtration system. These include dendrimers with ferrocene terminal groups that can oxidize glucose or reduce nitrates, carbosilane dendrimers with diaminoaryinickel(II) terminal groups which can catalyze the Karsch addition of tetrachloromethane to methacrylate, and complexes of Cu(II), Zn(II) and Co(III) with poly(propyleneimine) dendrimers that catalyze the hydrolysis of p-nitrophenyl diphenyl phosphate (a simulant for chemical warfare agents such as Sarin.) A number of dendritic catalytic systems have also been successfully implemented in continuous membrane reactors (Astruc and Chardac, (2001) Chem. Rev. 101:2991).

In addition, several research groups have also exploited the unique properties of dendrimers as nanoscale metal ion containers to synthesize metal bearing nanoparticles with catalytic properties (Scott et al. (2005) J. Phys. Chem. B. 109:692; Esumi et al. (2004) Langmuir. 20:237). These nanoparticles, commonly referred to as dendrimer nanocomposites, can be efficiently prepared by reactive encapsulation, a process that involves the complexation of guest metal ions followed by their reduction and immobilization inside a dendritic host and/or at its surface.

The inventor has shown the use of the Fe(0)/Fe(II) and Fe(II)/Fe(III) redox systems to develop water soluble and solid-supported dendritic nanoparticles to demonstrate the potential usefulness of dendrimer nanocomposites and transition metal ion-dendrimer complexes in water purification. The Fe(0)/Fe(II) and Fe(II)/Fe(III) redox couples can drive the oxidative and reductive transformations of a variety of organic and inorganic solutes. Reactions of relevance to water purification of water include the reductive dehalogenation of chlorinated hydrocarbons such PCE, the reduction of Cr(VI) to Cr(III), and the oxidation of As(III) to As(V) in the presence of dissolved oxygen. The initial focus was on the reductive dehalogenation of PCE by Fe(0) dendrimer nanocomposites in aqueous solutions (Example 4 includes data on the reduction of PCE by Fe(0) dendrimer nanocomposites).

The recycling reaction for redox active dendrimers may be accomplished by a number of means, including electrochemical regeneration. In such a reaction, the dendrimers may be placed in proximity to a an electrode, or redox couple that has a reduction potential that is favorable to oxidize or reduce the dendrimer catalyst to the state required for further rounds of catalysis. This may be accomplished in an electrochemical cell, where an electrical current is applied, or by reacting the dendrimers with another redox-active metal. In cases where the dendrimers carry out other types of catalytic reactions, different types of recycling processes may be desirable, as will be readily appreciated by those of skill in the art. A number of different redox-active dendrimer agents would be suitable for use in water filtration systems. Table 4 lists some commercially available dendrimers that may be used in the system.

The dendrimer-enhanced filtration process may also be used to remove anions from water. Anions have emerged as major water contaminants throughout the world because of their strong tendency to hydrate. In the US, the discharge of anions such as perchlorate (ClO₄⁻), pertechnetate (TcO₄⁻), chromate (CrO₄²⁻), arsenate (AsO₄³⁻), phosphate (HPO₄²⁻) and nitrate (NO₃⁻) into publicly owned treatment works, surface water, groundwater and coastal water systems is having a major impact on water quality. While significant research efforts have been devoted to the design and synthesis of selective chelating agents for cation separations, anion separations have received comparatively limited attention (Gloe, K., et al. (2003), Chem. Eng. Technol., 26:1107).

Unlike cations, anions have filled orbitals and thus do not readily bind to or co-ordinate with ligands. Anions do have a variety of geometries, however, and in many cases are sensitive to solution pH, so that shape-selective and pH-responsive receptors can be used to target anions. Because the charge-to-radius ratios of anions are also lower than those of cations, anion binding to ligands through electrostatic interactions tends to be weaker than cation binding. Anion binding and selectivity also depend on anion hydrophobicity and solvent polarity.

The present invention provides methods useful for removing anions from water. Dendrimer-bound groups that promote anion binding include but are not limited to alkyl amines, trialkyl amines, amide NH groups, and pyrrole NH groups. Examples of anions that may be removed by a DEF process using anion-binding dendrimers include but are not limited to ClO₄⁻, TcO₄⁻, CrO₄²⁻, AsO₄³, HPO₄², and NO₃⁻. An example of how perchlorate (ClO₄⁻) may be separated from water is shown in the Examples.

The following examples are offered by way of illustration and not by way of limitation.

### EXAMPLES

### Materials and Methods

Reagent grade sodium perchlorate (NaClO₄), sodium chloride (NaCl), sodium nitrate (NaNO₃), sodium bicarbonate (NaHCO₃) and sodium sulfate (Na₂SO₄) from Sigma-Aldrich were used, respectively, as sources of ClO₄⁻, Cl⁻, NO₃⁻, HCO₃⁻ and SO₄²⁻. Reagent grade nitrates of Co(II), Ag(I), Fe(III), and Ni(II) were used as sources of the metal ions. G5-NH₂ PPI and G4-NH₂ PAMAM dendrimers in methanol solutions were purchased from Sigma-Aldrich and used as received.

Ultrafiltration experiments were performed in a 10-mL stirred cell (Amicon, Model 8010) with an effective membrane area of 4.1 cm². For experiments at pressure, a 1-gallon stainless steel dispensing pressure vessel (Millipore) was connected to the stirred cell, and nitrogen gas was applied to the stirred cell via the reservoir.

Dendrimer concentrations were measured using a Shimadzu Model 1601 UV-Visible spectrophotometer at wavelength of 201 nm. Anion concentrations were determined by ion chromatography (Dionex DX-120 ion chromatograph, IonPac AS16 analytical column, IonPac AG16 guard column). Metal ion concentrations were determined by routine atomic absorption spectrophotometry. Details are described in Diallo, M. S. et al., (2004) Langmuir, 20:2640-2651, which is incorporated herein by reference.

### Example 1

### Recovery of Cu(II) from Aqueous Solutions Using PAMAM Dendrimers with Ethylene Diamine Core and Terminal NH₂ Groups

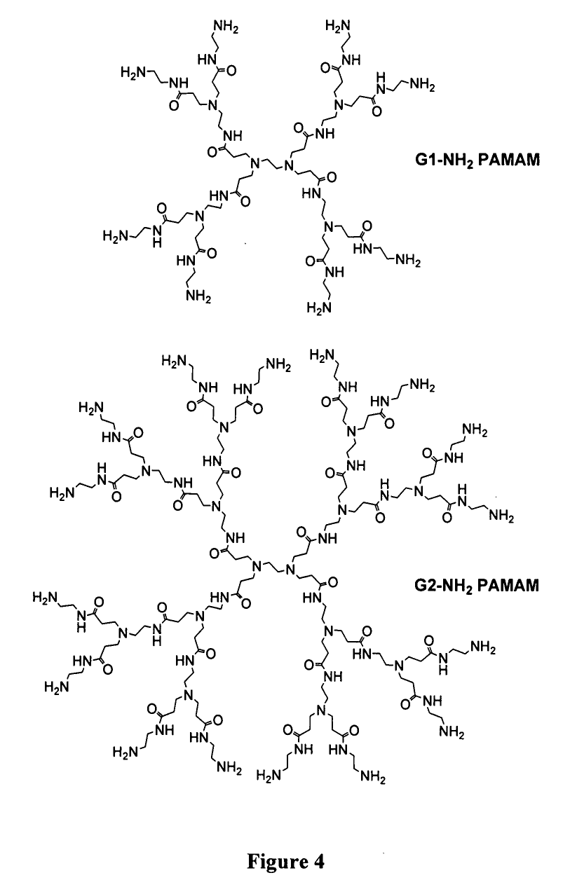

PAMAM dendrimers with ethylene diamine (EDA) core and terminal NH₂ groups are synthesized via a two-step iterative reaction sequence that produces concentric shells of β-alanine units (commonly referred to as generations) around the central EDA initiator core (FIG. 4). Selected physicochemical properties of these dendrimers are given in Table 5.

TABLE 5
Selected Properties of EDA Core Gx-NH₂ PAMAM
Dendrimers Evaluated in this Study.

| | ^{a}M_{wth} | | | | | ^{f}R_{G} | ^{g}R_{H} |
|---|---|---|---|---|---|---|---|
| Dendrimer | (Dalton) | ^{b}N_{NT} | ^{c}N_{NH2} | ^{d}pK_{NT} | ^{e}pK_{NH2} | (nm) | (nm) |
| G3-NH₂ | 6906 | 30 | 32 | 6.52 | 9.90 | 1.65 | 1.75 |
| G4-NH₂ | 14215 | 62 | 64 | 6.85 | 10.29 | 1.97 | 2.5 |
| G5-NH₂ | 28826 | 126 | 128 | 7.16 | 10.77 | 2.43 | 2.72 |

^{a}M_{wth}: Theoretical molecular weight.
^{b}N_{NT}: Number of tertiary amine groups.
^{c}N_{NH2}: Number of primary amine groups.
^{d}pK_{NT}: pKa of dendrimer tertiary amine groups.
^{e}pK_{NH2}: pKa of dendrimer primary amine groups.
^{f}R_{G}: dendrimer radius of gyration.
^{g}R_{H}: dendrimer hydrodynamic radius.

An extensive study of proton binding and Cu(II) complexation in aqueous solutions of EDA core PAMAM dendrimers of different generations and terminal groups has been carried out (Diallo, M. S. et al., (2004) Langmuir, 20:2640-2651, incorporated herein by reference). In consistence with Tanford's theory of solute binding to macromolecules (Tanford, C., (1961) Physical Chemistry of Macromolecules; John Wiley & Sons: New York.), the extent of binding (EOB) could be used to quantify Cu(II) uptake by the PAMAM dendrimers in aqueous solutions. The EOB of a metal ion in aqueous solutions of a dendrimer is readily measured by (i) mixing and equilibrating aqueous solutions of metal ion and dendrimer, (ii) separating the metal ion laden dendrimers from the aqueous solutions by ultrafiltration (UF) and (iii) and measuring the metal ion concentrations of the equilibrated solutions and filtrates by atomic absorption spectrophotometry. Table 6 compares the EOB of Cu(II) in aqueous solutions of EDA core Gx-NH₂ PAMAM dendrimers to the Cu(II) binding capacity of selected linear polymers with amine groups. On a mass basis, the EOB of Cu(II) to the Gx-NH₂ PAMAM dendrimers are much larger and more sensitive to solution pH than those of linear polymers with amine groups that have been used in previous PEUF studies.

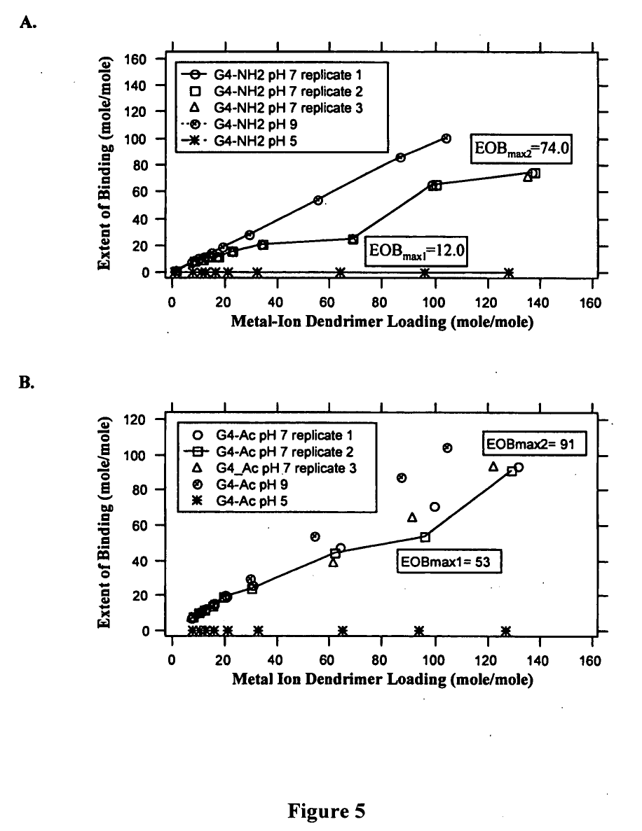

FIG. 5 provides evidence of the role of tertiary amine groups in the uptake of Cu(II) by EDA core PAMAM dendrimers in aqueous solutions. Both the G4-NH₂ and G4-Ac EDA core PAMAM dendrimers have 62 tertiary amine groups with pKa of 6.75-6.85. However, the G4-NH₂ PAMAM dendrimer has 64 terminal groups with pKa of 10.20. Conversely, the G4-Ac PAMAM dendrimer has 64 non ionizable terminal acetamide (NHCOCH₃) groups.

FIG. 5 shows that no binding of Cu(II) occurs to the G4-NH₂ and G4-Ac PAMAM dendrimers at pH 5, where all the primary and tertiary amine groups of the dendrimers are protonated. Conversely, significant binding of Cu(II) is observed at pH 7.0 and 9.0.

To account for the Cu(II) ions that are not specifically bound to the dendrimers' tertiary amine groups at pH 7.0, it was hypothesized the formation of octahedral complexes of Cu(II) with water molecules trapped inside the Gx-NH₂ PAMAM dendrimers. A two-site thermodynamic model of Cu(II) binding to Gx-NH₂ PAMAM was formulated based on (i) the postulated mechanisms of Cu(II) coordination with the dendrimer tertiary amine groups and bound water molecules, and (ii) Tanford's theory of solute binding to macromolecules in aqueous solutions. This model expresses the EOB of Cu(II) in aqueous solutions (at neutral pH) of Gx-NH₂ PAMAM dendrimers as function of metal ion-dendrimer loading (N_{Cu0}/N_{d}), number of dendrimer tertiary amine group (N_{N}^{d}), number of water molecules bound to the dendrimers (N_{H2O-d}), metal ion amine group/bound water coordination numbers (CN_{Cu(II)-N}^{d} and CN_{Cu(II)-H2O}^{d}) and the intrinsic association constants of Cu(II) to the dendrimer tertiary amine groups and bound water molecules (k_{Cu(II)-N}^{d} and k_{Cu(II)-H2O}^{d}).

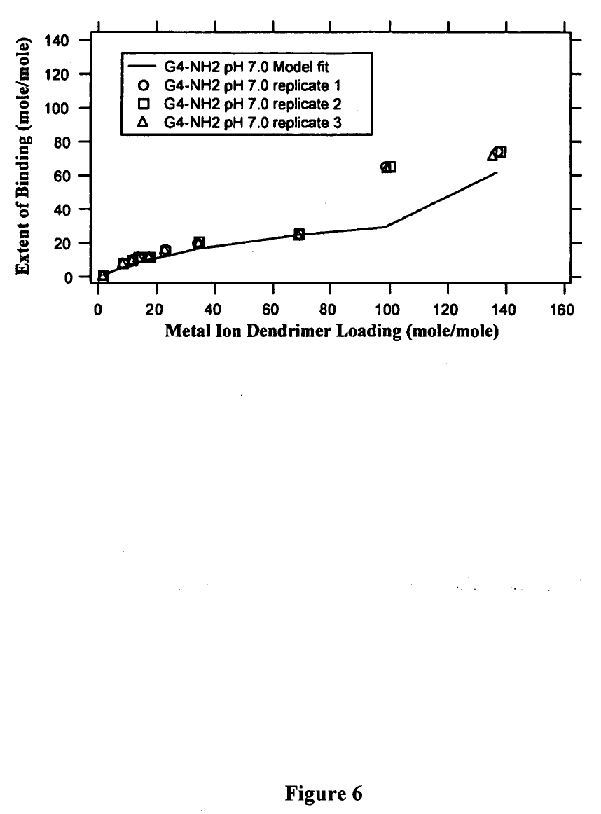

FIG. 6 highlights the results of a preliminary evaluation of the model. At low metal ion-dendrimer loadings, the model provides a good fit of the measured EOB of Cu(II) for the G4-NH₂ PAMAM dendrimer. The model also reproduces the increase in the EOB observed at higher metal ion-dendrimer loadings following the first plateau. Note that the two-site model can also be used to estimate the binding constant of Cu(II)

$$[ {K}_{Cu ( II ) - N}^{d} = \frac{{N}_{N}^{d}}{{k}_{Cu ( II ) - N}^{d}} ]$$

to the tertiary amine groups of a Gx-NH₂ PAMAM dendrimer. The K_{Cu(II)-N}^{d} values for the G4-NH₂ and G5-NH₂ EDA core PAMAM dendrimers are respectively equal to 3.15 and 3.78.

As shown in Table 7, the binding constants of Cu(II) to the tertiary amine groups of the Gx-NH₂ PAMAM dendrimers are comparable in magnitude to the formation constants of Cu(II)-ammonia complexes. Table 7 also suggests that the Gx-NH₂ PAMAM dendrimers will selectively bind Cu(II) over first-row transition metal ions such as Co(II) and Ni(II) and alkaline earth metal ions in wastewater such as Na(I), Ca(II) and Mg(II).

The dendrimer-enhanced filtration process (FIG. 1) is structured around two unit operations: 1. a clean water recovery unit and 2. a dendrimer recovery unit. In the clean water recovery unit, contaminated water is mixed with a solution of functionalized dendritic polymers (e. g., dendrimers, dendrigraft polymers, hyperbranched polymers, core-shell tecto(dendrimers), etc) to carry out the specific reactions of interest (metal ion chelation in this case).

Following completion of the reaction, the resulting solution is filtered to recover the clean water. The contaminant laden dendrimer solutions are subsequently sent to a second filtration unit to recover and recycle the functionalized dendritic polymers (FIG. 1). As a proof-of-concept study of this novel water treatment process, the inventor carried out dead-end ultrafiltration (UF) experiments to assess the feasibility of using DEUF to recover Cu(II) from aqueous solutions. The overall results of these experiments suggest that DEUF is a useful process for recovering Cu(II) from aqueous solutions.

UF experiments were carried out to measure the retention of dendrimers and Cu(II)-dendrimer complexes by model UF membranes. The experiments were performed in a 10-mL stirred cell (Amicon, Model 8010) at an applied pressure of 450 kPa (65 psi). For each run, the initial volume was 1 L. During each UF experiment, the stirred cell was operated for 4.5 hours with permeate collected every 30 minutes and flux measurements taken every 10 minutes.

Regenerated cellulose (RC) and polyethersulfone (PES) membranes (Ultracel Amicon YM and PB Biomax, Millipore Corp.) were evaluated. The RC and PES membranes had a diameter of 25 mm with molecular weight cut-off (MWCO) of 5000 Dalton (5 kD) and 10000 Dalton (10 kD). For the UF measurements of dendrimer retention in aqueous solutions, the concentrations of the G3-NH₂ (2.42265 10⁻⁵ mole/L), G4-NH₂ (8.49762 10⁻⁶ mole/L) and G5-NH₂ (5.31808 10⁻⁶ mole/L) PAMAM dendrimers were kept constant in all experiments. For the UF measurements of the retention of metal ion-dendrimer complexes, a Cu(II) concentration of 10 mg/L (0.00016 mole/L) was used in all experiments.

The molar ratio of Cu(II) to dendrimer NH₂ groups was also kept constant at 0.2 in all experiments. The Cu(II)-dendrimer solutions were maintained under constant agitation for 1 hour in the dispensing pressure vessel following adjustment of their pH with concentrated HCl or NaOH. The pH of aqueous solutions of PAMAM dendrimers and their complexes with Cu(II) can be controlled within 0.1-0.2 pH unit by addition of concentrated NaOH or HCl. The concentrations of metal ion in the feed and permeate were determined by atomic absorption spectrophotometry. Solute retention (R) was expressed as:

$$R = ( 1 - \frac{{C}_{p}}{{C}_{f}} ) \times 100 \qquad ( 1 )$$

where Cₚ and C_{f} are, respectively, the concentration of solute [i.e., dendrimer and Cu(II)] in the permeate and feed. The permeate flux Jₚ(L h⁻¹ m⁻²) and normalized permeate flux (Jₚₙ) were expressed as:

$$\begin{matrix}{J}_{p} = \frac{{Q}_{p}}{{A}_{UF}} & ( 2 ) \\ {J}_{pn} = \frac{{J}_{p}}{{J}_{po}} & ( 3 )\end{matrix}$$

where Qₚ is the permeate flow rate (L h⁻¹) and A_{UF}(m²) is the effective area of the UF membrane and Jₚₒ(L h⁻¹ m⁻²) is the initial permeate flux through the clean membranes.

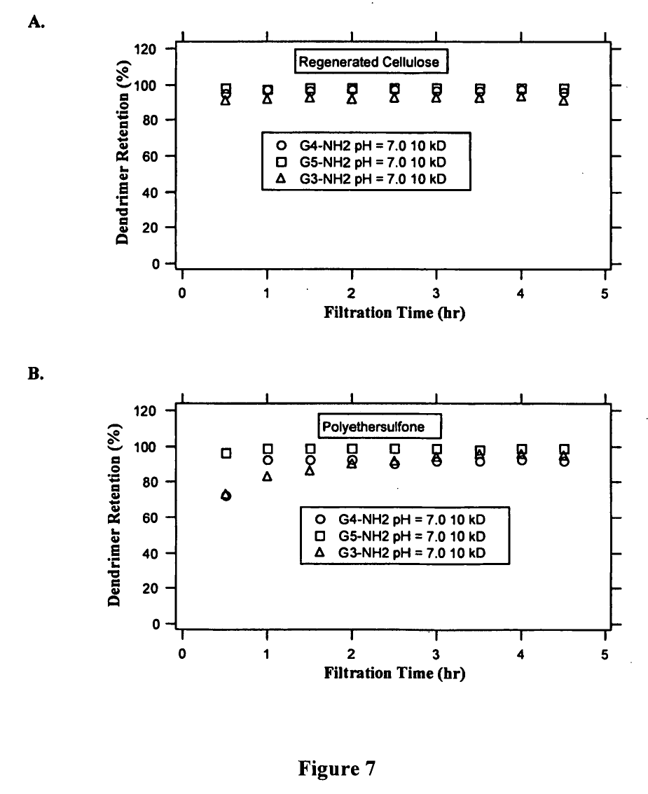

FIG. 7 highlights the effects of dendrimer generation and membrane chemistry on the retention of EDA core Gx-NH₂ PAMAM dendrimers in aqueous solutions at pH 7.0 and room temperature. The retentions of the G5-NH₂ PAMAM dendrimer by the 10 kD regenerated cellulose (RC) and polyethersulfone (PES) membrane are ≧97% in all cases. Such high retention values are expected for the G5-NH2 EDA core PAMAM dendrimer, a globular macromolecule with a low polydispersity and a molar mass of 28826 Dalton (Table 5). Retentions greater than 90% were also observed for the G4-NH₂ PAMAM dendrimer (FIG. 7). This dendrimer is also globular in shape and has very low polydispersity with a molar mass (14215 Dalton) greater than the MWCO of the 10 kD RC and PES membranes (Table 5). Possible explanations for the initial low retention (≈73%) of this dendrimer by the 10 kD PES membrane include measurement errors and/or the presence of impurities such as unreacted EDA and other lower molar mass reaction by-products in the G4-NH₂ PAMAM dendrimer sample.

FIG. 7 also shows that the retentions of the G3-NH₂ EDA core PAMAM dendrimer are lower than those of the higher generation dendrimers. This dendrimer has the lowest molar mass (Table 5). For both membranes, there is a significant retention of the G3-NH₂ dendrimer even though the MWCO of the dendrimers are 45% larger than the dendrimer molar mass (6906 Dalton). In fact, the retention of the G3-NH₂ dendrimer by the 10 kD RC membrane (FIG. 7) is comparable to that of a linear polyethyleneimine (PEI) polymer with an average molar mass of 50 to 60 kD (4). For UF membranes, the MWCO is usually defined as the molar mass of a globular protein with 90% retention.

Because dendritic polymers can be described as hybrids between polymer chains and colloidal particles, the use of the MWCO as indicator of dendrimer retention by UF membranes might not be adequate. Table 5 gives the radius of gyration (R_{G}) and hydrodynamic radius (R_{H}) of each EDA core Gx-NH₂ PAMAM dendrimer evaluated in this study. R_{G} provides a measure of the size of a particle/macromolecule regardless of its shape, while R_{H} gives the size of an “equivalent” spherical particle/macromolecule. The R_{G} and R_{H} of the PAMAM dendrimers were, respectively, estimated from small angle neutron scattering experiments and dilution solution viscosity measurements. They are comparable in magnitude to the mean pore surface diameters (1.93-3.14 nm) of a series of UF membranes (1-10 kD MWCO) that was recently characterized by Bowen and Doneva (Bowen, R. W., (2000) Surf Interf Analysis. 29:544-547.). Whereas the molar mass of each Gx-NH₂ PAMAM dendrimer increases by a factor of 2 at each generation, Table 5 shows that the corresponding radii of gyration and hydrodynamic radii increase linearly with dendrimer generation. Table 5 also shows no significant differences between the R_{G} and R_{H} of each Gx-NH₂ PAMAM dendrimer. While not wishing to be bound by any particular theory, the inventor believes that the slightly higher R_{H} values could be attributed for the most part to dendrimer hydration. Because the differences in the retentions of the EDA core Gx-NH₂ PAMAM dendrimers are (for the most part) comparable to the differences between their radii of gyration and hydrodynamic diameter, R_{G}/R_{H} appears to be a better indicator of dendrimer retention by UF membranes in aqueous solutions.

The overall results of the measurements of dendrimer retention by the 10 kD RC and PES membranes at pH 7.0 suggest that dendrimers such as the Gx-NH₂ EDA core PAMAM have much less tendency to pass through the pores of UF membranes than linear polymers of similar molar mass because of their much smaller polydispersity and persistent globular shapes in aqueous solutions over a broad range of solution pH and background electrolyte concentration.

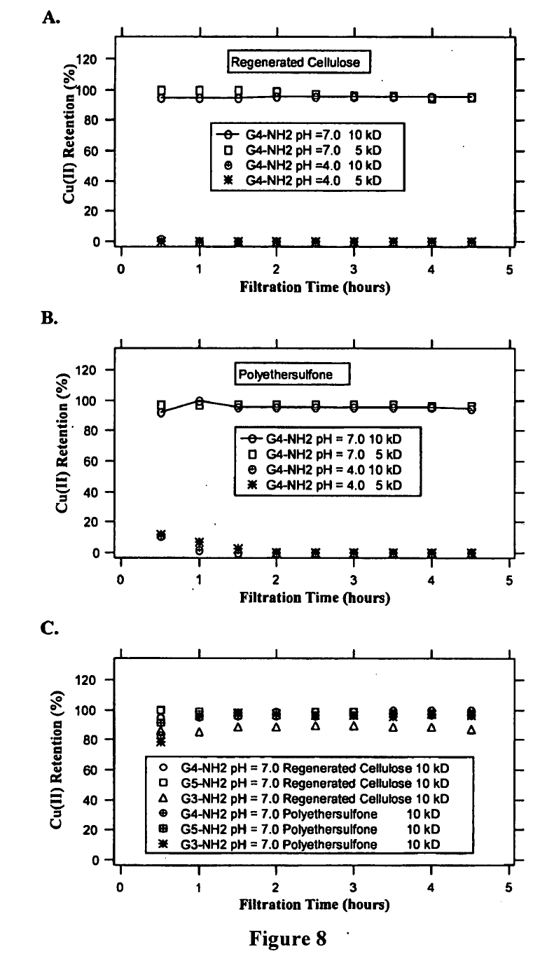

FIG. 8 highlights the effects of solution pH, membrane chemistry and MWCO on the retention of aqueous complexes of Cu(II) with a G4-NH₂ EDA core PAMAM dendrimer at room temperature. A Cu(II) concentration of 10 mg/L (0.00016 mole/L) was used in all experiments. The molar ratio of Cu(II) to dendrimer NH₂ groups was also kept constant at 0.2 to ensure that all the Cu(II) ions will be bound to the tertiary amine groups of the Gx-NH₂ PAMAM dendrimers at pH 7.0.

As shown in FIG. 8, 92 to 100% of the complexes of Cu(II) with the G4-NH₂ PAMAM dendrimer are retained by the RC and PES membranes at pH 7.0. These results are consistent with the measurements of dendrimer retention (FIG. 7) and metal ion binding measurements which show that 100% of the Cu(II) ions are bound to the G4-NH₂ PAMAM dendrimer at pH 7.0 and Cu(II) dendrimer terminal NH₂ groups molar ratio of 0.2. Consistent with the results of the metal ion binding measurements and dendrimer extent of protonation, no retention of Cu(II)-dendrimer complexes by the RC membranes occurs at pH 4.0 (FIG. 8). Slight retention of Cu(II) (˜10%) is initially observed for both PES membranes at pH 4.0; this may be due to measurement errors and/or metal ion sorption onto the PES membranes.

FIG. 8 illustrates the effects of dendrimer generation on the retention of Cu(II)-dendrimer complexes by the 10 kD membranes at pH 7.0. Here again, the observed retention values are consistent with the results of the dendrimer retention measurements (FIG. 7). Higher retention values are observed for the complexes of Cu(II) with the G5-NH2 PAMAM dendrimer. Conversely, smaller retention values for the Cu(II)-dendrimer complexes are observed with the G3-NH2 PAMAM dendrimer (FIG. 8). For both membranes, FIG. 8 shows significant retentions of Cu(II) complexes with the G3-NH2 dendrimer (86-89% for the 10 kD RC membrane and 80-97% for the 10 kD PES membrane) even though the MWCO of each membrane is 45% larger than the dendrimer molar mass. These results also suggest that the MWCO of a UF membrane might not be an adequate indicator of the retention of Cu(II)+dendrimer complexes by UF membranes in aqueous solutions.

Fouling is a major limiting factor to the use of membrane based processes in environmental and industrial separations. A characteristic signature of membrane fouling is a reduction in permeate flux through a membrane during filtration. The permeate fluxes of aqueous solutions of Cu(II) complexes with Gx-NH₂ PAMAM dendrimers through RC and PES membranes at pH 7.0 and 4.0 were measured. In these experiments, the Cu(II) concentration (10 mg/L) and molar ratio of Cu(II) to dendrimer NH₂ groups (0.2) were also kept constant.

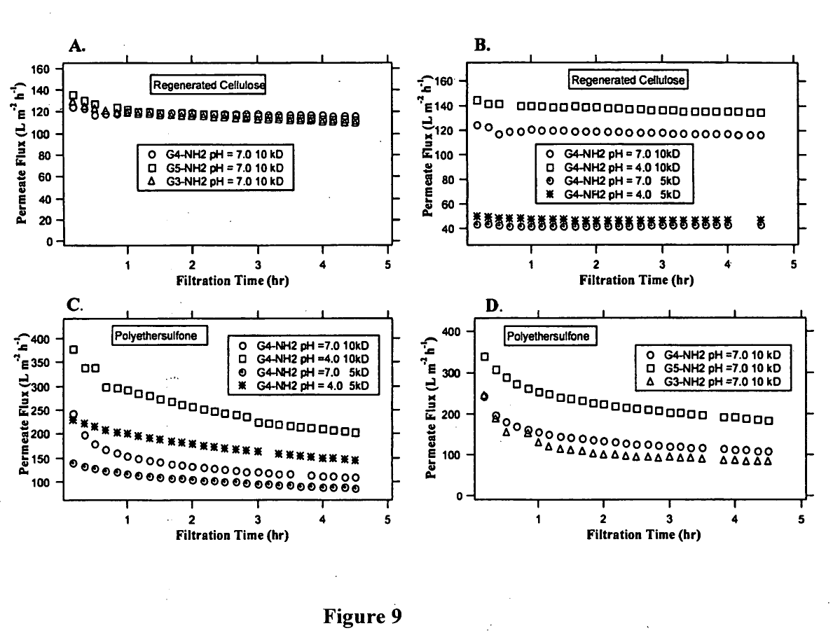

FIG. 9 shows the permeate fluxes through the RC and PES membranes. For the 10 kD RC membrane at pH 7.0, the permeate flux shows little change over the course of the filtration varying from 124.0 to 116.0 L m⁻² h⁻¹. A similar behavior is also observed at pH 4.0. However, in this case, the permeate fluxes are approximately 16% higher. The permeate fluxes through the 5 kD RC membranes also exhibit little variation (49.0-43.0 L m⁻² h⁻¹) during the course of the filtration at pH 7.0 and 4.0. FIG. 9 also shows that dendrimer generation does not significantly affect the permeate flux through the 10 kD RC membrane. This sharply contrasts the significant decline of permeate flux observed for the 5 kD and 10 kD PES membranes. Although the initial permeate fluxes are much larger for the PES membranes, significant flux declines (45 to 63%) occur during the filtration of aqueous solutions of Cu(II) complexes with the G4-NH₂ PAMAM dendrimer at pH 7.0 and 4.0 (FIG. 9). In this case, we also observe a significant impact of dendrimer generation on the permeate flux of aqueous solutions of Cu(II)-dendrimer complexes through the 10 kD PES membranes at pH 7.0.

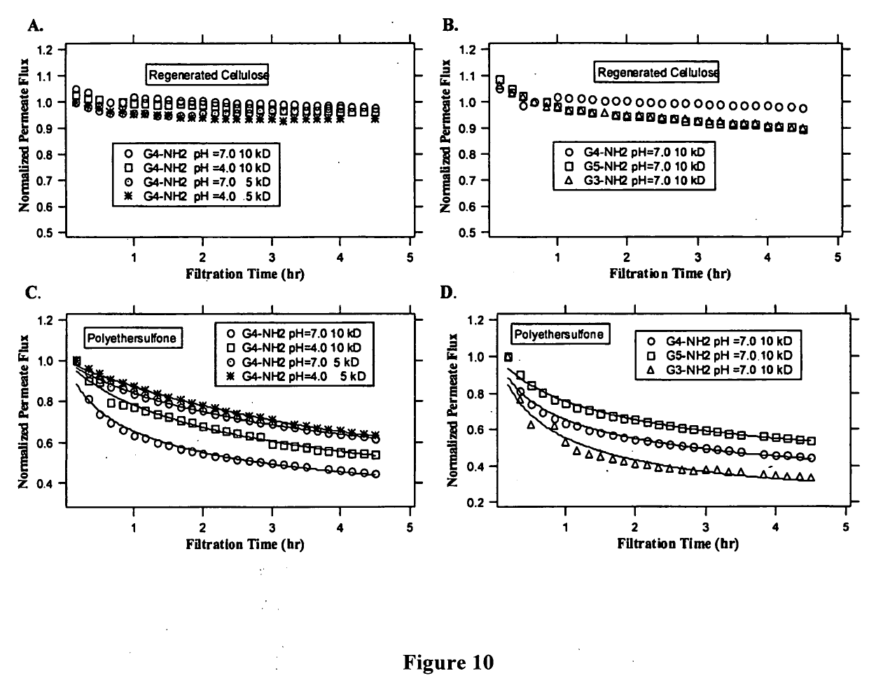

FIG. 10 shows a decline in the normalized permeate fluxes for both the RC and PES membranes during the filtration of aqueous solutions of Cu(II) complexes with Gx-NH₂ PAMAM dendrimer at pH 7.0. For the 5 kD and 10 kD RC membranes, a small decline in the relative permeate flux (7 to 18%) is observed. However, the decrease in relative permeate flux (46 to 81%) is much larger for the PES membranes. At pH 4.0, a significant decrease in permeate flux (13 to 68%) is observed for the PES membranes. These results suggest that the PES membranes are more susceptible to fouling by the aqueous solutions of Gx-NH₂ PAMAM dendrimer+Cu(II) than the corresponding RC membranes.

The mechanisms of fouling of UF membranes are not well understood. For organic macromolecules such as proteins, linear polymers and humic acids, membrane fouling may be caused by (i) concentration polarization resulting from solute accumulation near a membrane surface, (ii) pore blockage by solute sorption onto the surface of a membrane or within its pores and (iii) the formation of a cake layer by sorption/deposition of solutes on a membrane surface. To learn more about the fouling of the RC and PS membranes by EDA core Gx-NH₂ PAMAM dendrimers, the data analysis software IGOR Pro Version 4.0 from WaveMetrics, Inc was used to fit the normalized permeate fluxes to two phenomenological models of membrane fouling (FIG. 7). The first model is a pore blockage model that expresses the decline in the normalized permeate flux as an exponential decay function. This model did not provide a good fit of the data (results not shown). The second model expresses the decline in the normalized permeate flux as a power-law function (Zeman, L. J. et al., (1996) Microfiltration and Ultrafiltration. Principles and Applications; Marcel Dekker: New York. and Kilduff, J. E. et al., (2002) Env. Eng. Sci. 19:477-495.):

Jₚₙ=(1+kt)⁻ⁿ (4)

where k(h⁻¹) is a filtration rate constant and n is a dimensionless exponent. As shown in FIG. 10 and Table 8, this model provides a very good fit of the normalized permeate flux for the all the PES membranes. For the G4-NH₂ PAMAM dendrimer, the estimated values of n for the 10 kD PES membranes are 0.31±0.03 at pH 7.0 and 0.39±0.03 at pH 4.0 (Table 8). For the 5 kD PES membrane, the n values are equal to 0.36±0.02 at pH 7.0 and 0.63±0.05 at pH 4.0 (Table 8). The n values for the G3-NH₂ and G5-NH₂ PAMAM dendrimers membranes are, respectively, equal to 0.45±0.05 and 0.30±0.02 for the 10 kD PES membranes at pH 7.0. For dead-end ultrafiltration, Zeeman and Zydney (Zeman, L. J. et al., (1996) Microfiltration and Ultrafiltration. Principles and Applications; Marcel Dekker: New York.) and Kilduffet al. (Kilduff, J. E. et al., (2002) Env. Eng. Sci. 19:477-495.) have shown that the decline in permeate flux can be described by a pore constriction model when n˜2. This model assumes that the rate of change in the membrane pore volume is proportional to the rate of particle convection to the membrane surface. When n˜0.5, the decline in permeate flux in a dead-end ultrafiltration process can be described by a cake filtration model. This model attributes the loss of permeate flux to particle deposition on the membrane surface. Based on the estimated n values given in Table 8, the sorption and deposition of dendrimer-Cu(II) complexes onto the membrane surfaces appears to be a plausible fouling mechanism for the PES membranes. It is thought that the small decline in the relative permeate fluxes (7 to 18%) through the 5K and 10 K RC membranes (FIG. 10) could also be attributed to the sorption of dendrimer-Cu(II) complexes onto the membrane surfaces.

TABLE 8
Fitted Model Parameters for the Normalized Permeate
Flux of Aqueous Solutions of EDA Core Gx-NH₂ PAMAM
Dendrimers + Cu(II) through Polyethersulfone Membranes

| Dendrimer | Membrane MWCO | pH | ^{a}k(h⁻¹) | ^{a}n | ^{b}χ² |
|---|---|---|---|---|---|
| G4-NH₂ | 10 kD | 7.0 | 2.98 ± 0.58 | 0.31 ± 0.03 | 0.016 |
| G4-NH₂ | 10 kD | 4.0 | 0.86 ± 0.13 | 0.39 ± 0.03 | 0.007 |
| G4-NH₂ | 5 kD | 7.0 | 0.62 ± 0.06 | 0.36 ± 0.02 | 0.001 |
| G4-NH₂ | 5 kD | 4.0 | 0.24 ± 0.05 | 0.63 ± 0.05 | 0.001 |
| G5-NH₂ | 10 kD | 7.0 | 1.53 ± 0.21 | 0.30 ± 0.02 | 0.016 |
| G3-NH₂ | 10 kD | 7.0 | 2.74 ± 0.75 | 0.45 ± 0.05 | 0.037 |

^{a}k and n are determined by fitting the measured relative permeate fluxes to Equation 4.
^{b}Goodness of fit parameter.

In Table 8, the goodness of fit parameter is defined as

$${χ}^{2} = {\sum }_{i} ( \frac{y - {y}_{i}}{{σ}_{i}} ) ; \qquad ( 5 )$$

where y is the fitted value, yᵢ is the measured value and σᵢ is the estimated standard deviation for yᵢ.

Polymer enhanced ultrafiltration (PEUF) has emerged as a promising process for recovering metal ions from aqueous solutions. The efficiency of PEUF-based water treatment will depend on several factors including: (i) polymer binding capacity and selectivity toward the targeted metal ions, (ii) polymer molar mass. (iii) responsiveness to stimuli such as solution pH, (iv) polymer sorption tendency onto UF membranes and (v) polymer stability and non-toxicity. An ideal polymer for PEUF treatment of water should be highly soluble, have a high binding capacity and selectivity toward the targeted ions, and a low sorption tendency toward UF membranes. Its molar mass should be high enough to ensure complete retention by UF membranes without significant polymer leakage or decrease in permeate flux. The metal ion binding capacity of an ideal polymer for PEUF should also exhibit sensitivity to stimuli such as solution pH over a range broad enough to allow efficient recovery of the metal and recycling of the polymer. An ideal polymer for PEUF should also be non-toxic and stable with a long life cycle to minimize polymer consumption.

On a mass basis, the Cu(II) binding capacities of the Gx-NH₂ PAMAM dendrimers are much larger and more sensitive to solution pH (Table 6) than those of linear polymers with amine groups. Table 7 shows that Na(I), Ca(II) and Mg(II) have very low binding affinity toward ligands with N donors such as NH₃. Thus, the high concentrations of Na(I), Ca(II) and Mg(II) found in most industrial wastewater streams are not expected to have a significant effect on the Cu(II) binding capacity and selectivity of NH₂ PAMAM dendrimers.

TABLE 6
Cu(II) Binding Capacity (mg/g) of Gx-NH₂ EDA Core PAMAM Dendrimers
and Linear Polymers with Amine Groups in Aqueous Solutions

| | Binding Capacity | Binding Capacity | | Binding Capacity |
|---|---|---|---|---|
| Chelating Ligand | pH 9.0 | pH 6-8.0 | | pH 2.0-5.0 |
| ^{a}G3-NH₂ PAMAM | 420.0 | 333.0 | (pH 7.0) | 0 |
| ^{a}G4-NH₂ PAMAM | 451.0 | 329.0 ± 8.0 | (pH 7.0) | 0 |
| ^{a}G5-NH₂ PAMAM | 395.31 | 308.0 ± 20.0 | (pH 7.0) | 0 |
| ^{b}Poly(ethyleneimine) | NA | 153.0 | (pH 6.0) | 55 (pH 2.4)-189 (pH 4.0) |
| ^{b}Poly(ethylene) | NA | 120.0 | (pH 6.0) | NA |
| pyridine 2-aldimine) | | | | |
| ^{b}Poly(ethylene | NA | 120.0 | (pH 6.0) | NA |
| aminodiacetic acid) | | | | |

^{a}Cu(II) binding capacities estimated from Cu(II) extent of binding (Diallo, M. S. et al., (2004) Langmuir, 20: 2640-2651.)
^{b}Cu(II) binding capacities from Geckeler and Volchek, (1996) Envir. Sci. Technol 30, 725-734.

TABLE 7
Formation Constants of Selected Metal Ion-Ammonia Complexes
and Estimated Binding Constants of Cu(II) to the Tertiary
Amines Groups of EDA Core Gx-NH₂ PAMAM Dendrimers

| | ^{a}log K₁ | ^{b}log K_{Cu(II)-N}^{d} | ^{c}log K_{Cu(II)-N}^{d} |
|---|---|---|---|
| Metal Ion | (NH₃) | (G4-NH₂) | (G4-NH₂) |
| Cu(II) | 4.04 | 3.15 | 3.78 |
| Co(II) | 2.10 | ^{d}NA | ^{d}NA |
| Ni(II) | 2.70 | ^{d}NA | ^{d}NA |
| Na(I) | −1.1 | ^{d}NA | ^{d}NA |
| Mg(II) | 0.23 | ^{d}NA | ^{d}NA |
| Ca(II) | −0.2 | ^{d}NA | ^{d}NA |

^{a}Data are taken from Martell and Hancock (Martell, A. E. et al., (1996), Metal Complexes in Aqueous Solutions; Plenum Press: New York.).
^{b}Estimated using the two-site thermodynamic model of Cu(II) binding to Gx-NH2 PAMAM dendrimers at neutral pH developed by Diallo et al. (Diallo, M. S. et al., (2004) Langmuir, 20: 2640-2651.).

As shown in FIG. 8, separation of the dendrimer-Cu(II) complexes from solutions can simply be achieved by ultrafiltration. The metal ion laden-dendrimers can also be regenerated by decreasing the solution pH to 4.0 (FIG. 8). Dendritic macromolecules such the Gx-NH₂ EDA core PAMAM dendrimers have also much less tendency to pass through the pores of UF membranes (FIG. 7) than linear polymers of similar chemistry and molar mass because of their much smaller polydispersity and globular shape. They have also a very low tendency to foul the commercially available regenerated cellulose (RC) membranes evaluated in this study (FIGS. 9, 10, and 11). Whereas the intrinsic viscosity of a linear polymer increases with its molar mass, that of a dendrimer decreases as it adopts a molar globular shape at higher generations. Because of this, dendrimers have a much smaller intrinsic viscosity than linear polymers with similar molar mass. Thus, comparatively smaller operating pressure, energy consumption and loss of ligands by shear-induced mechanical breakdown could be achieved with dendrimers in tangential/cross-flow UF systems typically used to recover metal ions from contaminated water. These unique properties of the Gx-NH₂ EDA core PAMAM dendrimers along with their low toxicity make dendrimer-enhanced filtration a particularly attractive process for recovering metal ions such as Cu(II) from contaminated water.

### Example 2

### Use of PAMAM Dendrimers for Binding to Additional Metals

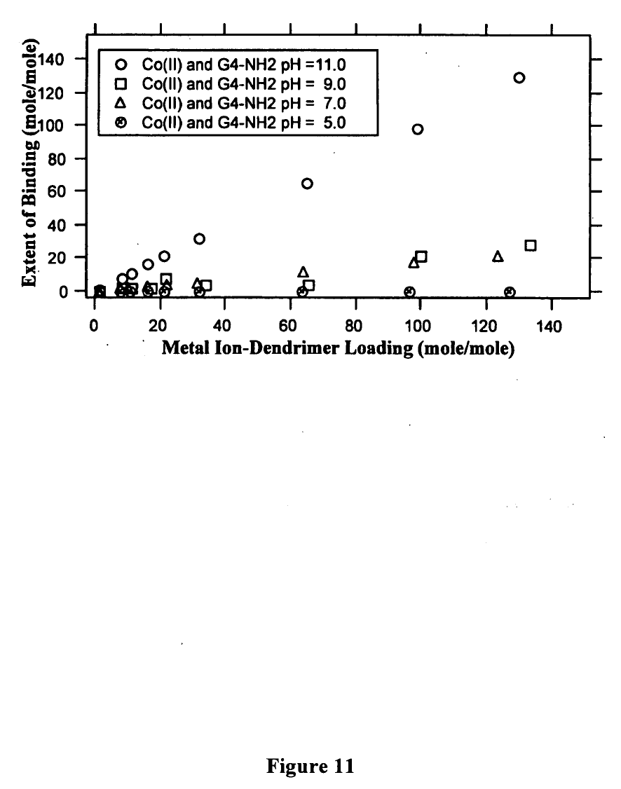

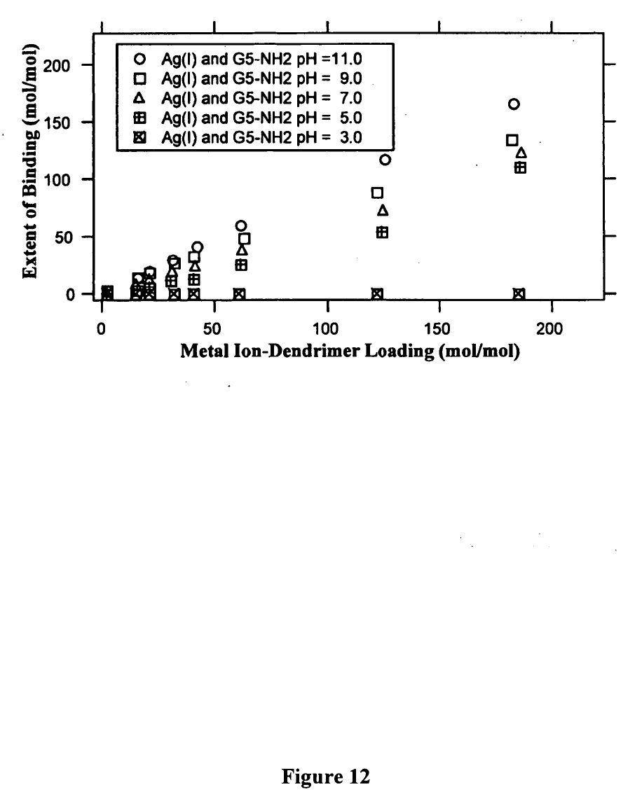

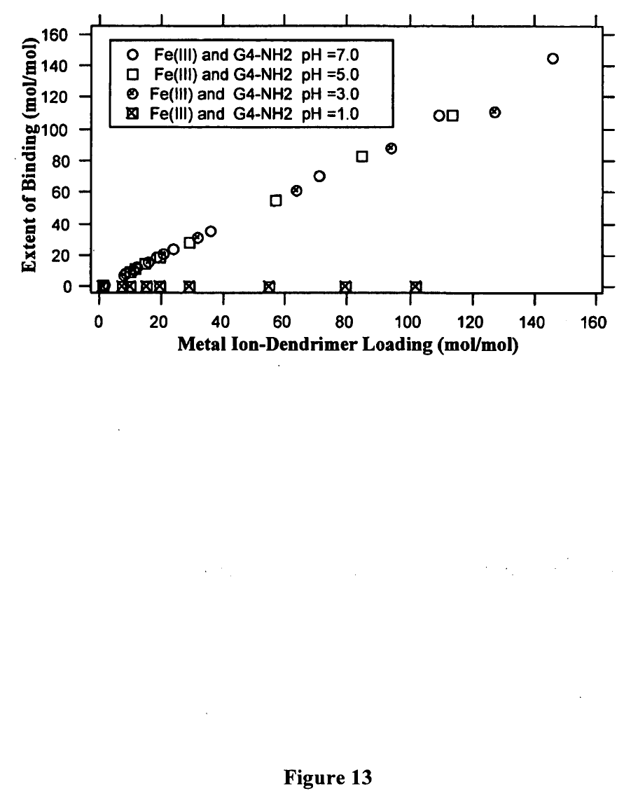

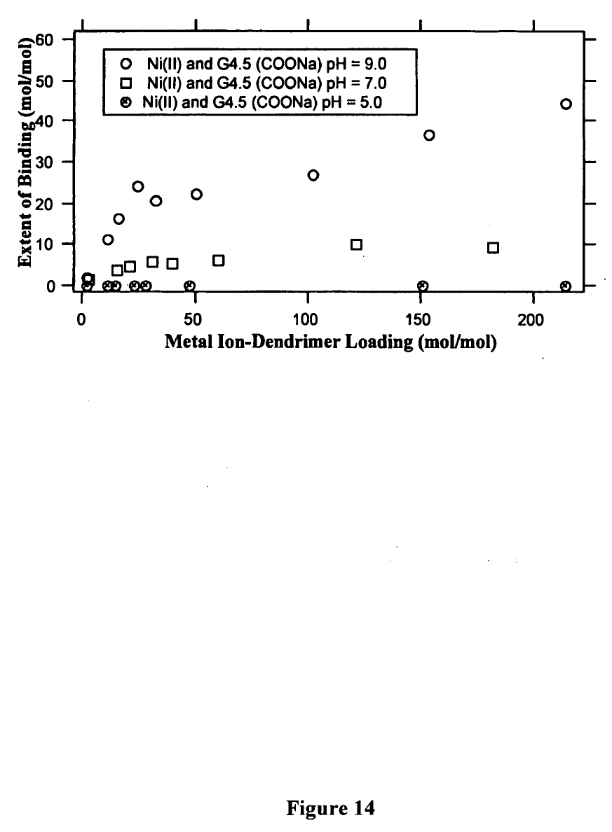

By the methods described above, the binding of Co(II), Ag(I), Fe(III), and Ni(II) to PAMAM dendrimers was tested at room temperature as a function of pH and metal ion dendrimer loading. The extent of binding for Co(II) is shown in FIG. 11, for Ag(I) in FIG. 12, for Fe(III) in FIG. 13, and the extent of binding of Ni(II) is shown in FIG. 14.

### Example 3

### Use of Dendrimer Enhanced Filtration (DEF) to Remove Anions

This example focuses on the use of dendritic ligands to bind perchlorate (ClO₄⁻). The dendrimers used were fifth generation (G5-NH₂) poly(propylene) (PPI) dendrimer with a diaminobutane (DAB) core and terminal NH₂ groups. This is a water-soluble dendrimer with 64 terminal NH₂ groups (pKₐ=9.8) and 62 internal tertiary amine groups (pKₐ=6.0) with a theoretical molar mass of mass 7168 Dalton (10).

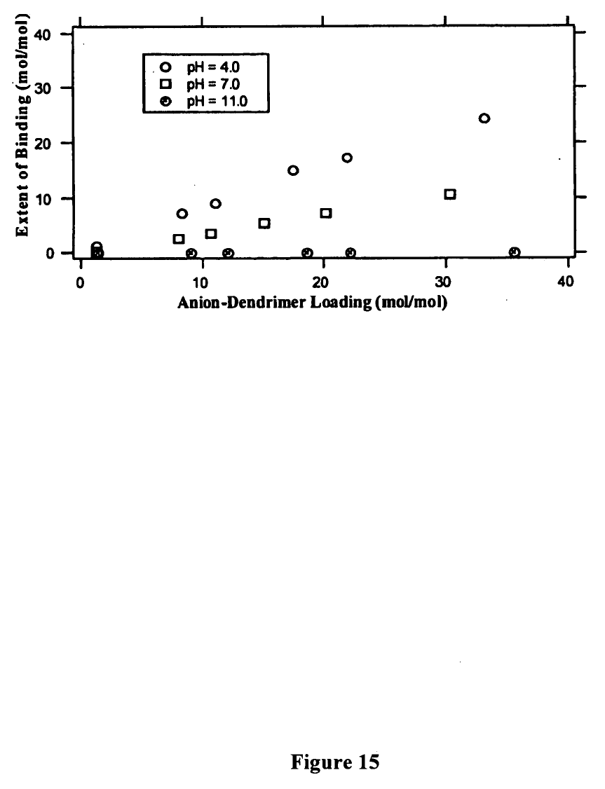

The binding assay procedure consisted of (i) mixing and equilibrating aqueous solutions of perchlorate and dendrimer at room temperature, (ii) separating the perchlorate-dendrimer complexes from the aqueous solutions by ultrafiltration and (iii) measuring the concentration of perchlorate in the equilibrated solutions and filtrates. FIG. 15 shows the EOB of perchlorate in aqueous solutions of the G5-NH₂ PPI dendrimer as a function of anion-dendrimer loading and solution pH. In these experiments, the molar ratio of anion-dendrimer NH₂ group was varied to prepare solutions with a given perchlorate dendrimer loading. At pH 4.0, the terminal NH₂ groups and tertiary amine groups of the PPI dendrimer are protonated. In this case, we observe significant binding of perchlorate, up to 48 ClO₄⁻ anions per mole of dendrimer.

On a mass basis, this corresponds to an EOB of 923 mg of perchlorate per g of dendrimer. This is approximately 9 times larger than the amount of ClO₄⁻ adsorbed (˜100 mg/g) after 24 hours onto the bifunctional ion exchange resins that are currently being used to treat water contaminated by perchlorate (Moore, et al. (2003) Environ. Sci. Technol., 37:3189; Brown, et al. (2000) Perchlorate in the Environment. Urbansky, T. E., ed., Kluver Academic, New York, pp 155-176). The EOB of perchlorate to the G5-NH₂ PPI dendrimer was measured after an equilibration time of 30 minutes, compared to 24 hours for the ion exchange resin. The fast binding kinetics of dendrimers are an expected advantage of homogenous liquid phase processes such as DEF.

FIG. 15 shows significant binding of perchlorate to the G5-NH₂ PPI dendrimer at pH 7.0 even though a significant fraction (>50%) of its tertiary amine groups (pKₐ=6.0) are not protonated. This suggests that the protonated terminal NH₂ (pKₐ=9.8) groups provide a significant fraction of the electrostatic free energy of perchlorate binding to the G5-NH₂ PPI dendrimer. Little binding of perchlorate occurs at pH 11.0, where all amino groups are neutral. The overall results are consistent with the hypothesis that a combination of protonation of the amine groups of the dendrimer and the hydrophobicity of its internal cavities provides the driving force for perchlorate binding and/or encapsulation by G5-NH₂ PPI in aqueous solutions.

Batch experiments were carried out in deionized water and model electrolyte solutions to measure the extent of binding (EOB) of ClO₄⁻ as a function of (i) anion-dendrimer loading, (ii) solution pH and (iii) reaction time. The binding assay procedure consisted of (i) mixing and equilibrating aqueous solutions of ClO₄⁻ and dendrimer at room temperature, (ii) separating the perchlorate-dendrimer solutions from the aqueous solutions by ultrafiltration (UF) and (iii) measuring the ClO₄⁻ concentrations of the initial solutions and filtrates.

The concentrations of perchlorate in the solutions [ClO₄⁻]₀ land filtrates [ClO₄⁻]_{f} were measured using a Dionex DX120 ion chromatograph with conductivity suppression and detection. The ClO₄⁻ detection limit was ˜4 ppb. The concentration of bound perchlorate [ClO₄⁻]_{b} (mole/L) was expressed as:

[ClO₄⁻]_{b}=[ClO₄⁻]ₒ−[ClO₄⁻]_{f} (6)

The EOB (moles of bound perchlorate per mole of dendrimer), the concentration of dendrimer [C_{d}] (mole/L) in solution and the fractional binding [FB] (%) were expressed as:

$$\begin{matrix}EOB = \frac{{[ {ClO}_{4}^{-} ]}_{b}}{{C}_{d}} & ( 7 ) \\ {C}_{d} = \frac{{m}_{d}}{{V}_{s} {M}_{wd}} & ( 8 ) \\ FB = 100 \times \frac{{[ {ClO}_{4}^{-} ]}_{b}}{{[ {ClO}_{4}^{-} ]}_{o}} & ( 9 )\end{matrix}$$

where m_{d} (g) is the mass of dendrimer in solution, V_{S} (L) is the solution volume and M_{wd} (g/mole) is the dendrimer molar mass (Table 9).

TABLE 9
Extents of Protonation of Dendrimers

| | pH 4.0 | pH 7.0 | pH 9.0 | pH 11.0 |
|---|---|---|---|---|
| G5-NH₂ PPI | | | | |
| α_{NT} | 0.99 | 0.11 | 0.00 | 0.00 |
| α_{NH2} | 0.99 | 0.99 | 0.81 | 0.41 |
| G4-NH₂ PAMAM | | | | |
| α_{NT} | 0.99 | 0.17-0.41 | 0.00 | 0.00 |
| α_{NH2} | 0.99 | 0.99 | 0.63-0.91 | 0.02-0.09 |

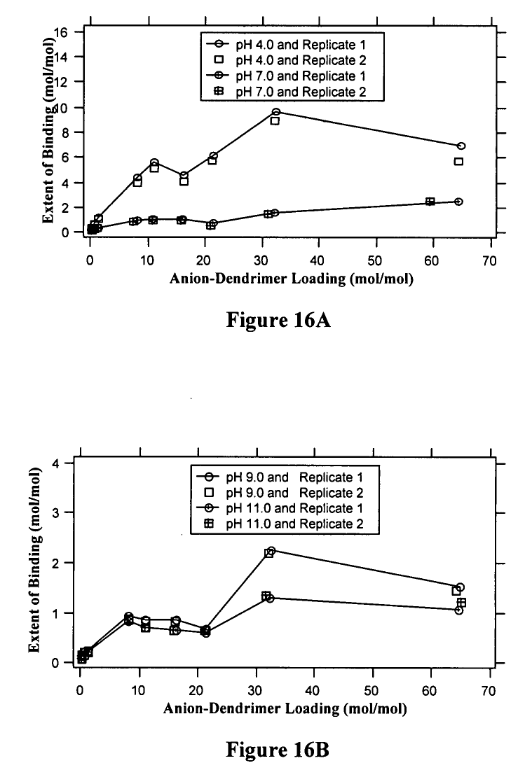

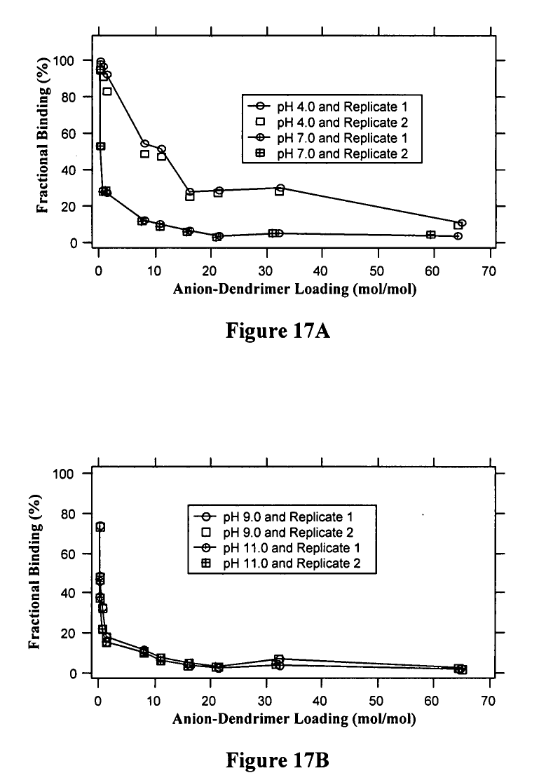

The extents of protonation of the tertiary and primary amine groups (α_{NT} and α_{NH2}) of the PPI and PAMAM dendrimers were calculated using the Henderson-Hasselbach equation:

$$log \frac{{α}^{i}}{1 - {α}^{i}} = {pK}_{a}^{i} - pH \qquad ( 10 )$$

where i identifies the basic group (NT or NH₂). FIGS. 16 and 17 show the effects of anion-dendrimer loading and solution pH on the EOB and FB of ClO₄⁻ to a G5-NH₂ PPI dendrimer in deionized water at room temperature and reaction time of 1 hour. In these experiments, the molar ratio of perchlorate to dendrimer was varied to prepare solutions with a given anion- dendrimer loading. Three replicate measurements were carried out in each set of experiments; to preserve the clarity of the figures, only duplicate measurements are plotted. FIG. 16 shows that the EOB of perchlorate goes through a series of distinct binding steps at pH 4.0 as anion-dendrimer loading increases. First is a gradual increase of the EOB to a maximum of ˜6.0 moles of bound ClO₄⁻ per mole of dendrimer when the anion-dendrimer loading is ˜11.0. This is a followed by another increase of the EOB [˜9.0 for an anion-dendrimer loading of ˜32.0] and a slight decrease to a value of ˜7.0 when the anion-dendrimer loading is ˜64.0. The FB of perchlorate also exhibits a series of distinct binding steps in aqueous solutions of the G5-NH₂ PPI dendrimer (FIG. 17). At pH 4.0 and low anion-dendrimer loading (˜0.17-1.29), the FB is greater than 90% in all cases. The FB sharply decreases and levels off around 30% followed by a slight decrease as anion-dendrimer loading increases.

Each successive perchlorate binding step involves an initial increase of solute binding followed by a second increase, this behavior is attributed to the presence of dendrimer sites with different binding capacity and affinity for ClO₄⁻. As the sites near the dendrimer surface become filled, ClO₄⁻ guest ions diffuse into the interior of the dendrimer host to occupy its internal and confined cavities. This nonspecific mode of guest uptake by a macromolecular host is referred to as “topological trapping” in the supramolecular chemistry literature. The slight decrease of the EOB of ClO₄⁻ to a value of ˜7.0 when the anion-dendrimer loading reaches ˜64 could be attributed to the release of loosely bound guests due to conformational changes, as the G5-NH₂ PPI dendrimer rearranges itself to accommodate perchlorate anions in the interior.

Two potential driving forces for perchlorate uptake by the G5-NH₂ PPI dendrimer are electrostatic interactions with the protonated amine groups of the dendrimer, and hydrophobic partitioning in the dendrimer interior, which reportedly has a polarity comparable to that of hexane (Pistolis and Malliaris, Langmuir. (2002), 18:246-251). The role of the electrostatic interactions is illustrated by the pH dependence of binding. At pH 4.0, 99% of the dendrimer tertiary amine groups are protonated (Table 9). As shown in FIG. 17, 98% of ClO₄⁻ are bound to the dendrimer at pH 4.0 when the anion-dendrimer loading is ˜0.31. At pH 7.0, 99% of the primary amine groups remain protonated, but only 11% of the tertiary amine groups of the dendrimer are protonated (Table 9), and the FB of ClO₄⁻ drops to ˜53%.

At an anion-dendrimer loading of 32.0, the maximum EOB of ClO₄⁻ decreases by a factor of 4 at pH 7.0 compared to that at pH 4.0. The maximum EOB of ClO₄⁻ is also smaller at pH 9.0 even though ˜81% of the dendrimer NH₂ groups remain protonated.

FIG. 16 also shows some binding of ClO₄⁻ at pH 11.0 [with a maximum EOB˜1.29 at anion-dendrimer loading of 32.0], where virtually all amines of the G5-NH₂ PPI dendrimer are unprotonated. This “residual” binding, not apparent in FIG. 15, may be attributed to topological trapping of ClO₄⁻ anions in the hydrophobic interior of the PPI dendrimer.

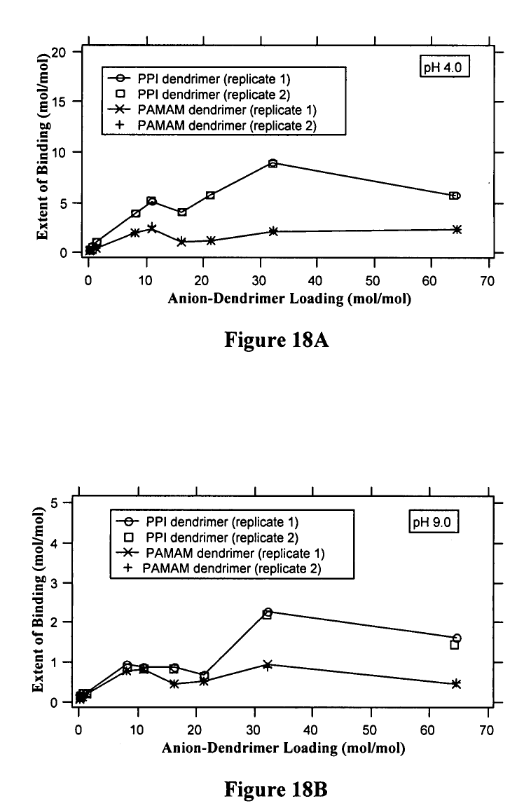

Perchlorate has a larger ionic radius and hydration free energy than most anions present in groundwater and surface water. Thus, dendrimers with hydrophobic cavities and positively charged internal groups might selectively bind ClO₄⁻ over more hydrophilic anions such as Cl⁻, NO₃⁻, SO₄²⁻ and HCO₃⁻. To test the hypothesis that the G5-NH₂ PPI dendrimer provides a more favorable environment for the partitioning of ClO₄⁻ anions than the more hydrophilic PAMAM dendrimers, we measured perchlorate uptake in aqueous solutions of a G4-NH₂ PAMAM dendrimer at pH 4.0 and 9.0. This dendrimer has the same number of tertiary amine and primary groups than the G5-NH₂ PPI dendrimer. The extents of protonation of the tertiary and primary amine groups of the PPI and PAMAM dendrimers are comparable (Table 9). However, the G4-NH₂ PAMAM dendrimer is more hydrophilic, having 64 additional internal amide groups that can interact with water through hydrogen bonding. Molecular dynamics simulations of Gx-NH₂ PAMAM dendrimers with explicit water molecules carried out by Goddard and co-workers (30) showed extensive water penetration in the interior of a G4-NH₂ PAMAM dendrimer. Niu et al. (27) reported an estimated value of ε_{dendrimer}=23 for the internal dielectric constant of a G4-NH₂ PAMAM dendrimer thereby suggesting that its polarity is similar to that of ethanol, which has a dielectric constant εₑₜₕₐₙₒₗ=24 (31). FIG. 18 shows the EOB of perchlorate to the G4-NH₂ PAMAM dendrimer in deionized water. In this case, the EOB curve also goes through a series of distinct binding steps at pH 4.0 with a maximum EOB ˜2.3. This value is smaller (by a factor of 4.5) than the EOB of ClO₄⁻ to the PPI dendrimer in deionized water even though the tertiary amine groups of the PAMAM dendrimer are fully protonated at pH 4.0 (Table 9). Similarly, at pH 9.0, the maximum EOB of ClO₄⁻ (˜0.9) in aqueous solutions of the PAMAM dendrimer is also smaller (by a factor of ˜2.4). These results are consistent with our hypothesis that the hydrophobic G5-NH₂ PPI dendrimer provides a more favorable environment for ClO₄⁻ than the more hydrophilic G4-NH₂ PAMAM dendrimer.

The results of these preliminary studies suggest that dendrimers provide ideal building blocks for the development of selective ligands for anions such as ClO₄⁻, CrO₄²⁻ and HPO₄²⁻. Thus, it is expected that the replacement of the terminal and internal N groups of PPI and PAMAM dendrimers with alkyl amines, trialkyl amines, and various heterocyclic bases will provide versatile anion-selective dendritic ligands for water purification. The pK_{b} values of the ligands can be tuned to bind anions at lower pH, and release the anions at higher pH when the basic ligands become neutralized. In fact this is a general ligand design strategy that could be applied to most dendritic macromolecules with ionizable N groups.

### Example 4

### Use of DEF to Remove Target Anions in the Presence of Interfering Anions

To assess the effects of competing anions on perchlorate uptake by the G5-NH2 PPI dendrimer, the uptake of perchlorate by a G5-NH₂ PPI dendrimer was studied in model electrolyte solutions containing the potentially interfering ions Cl⁻, NO₃⁻, HCO₃⁻ and SO₄²⁻. The low background electrolyte (Electrolyte 1) consisted of a solution of 0.1 mM NaCl, 0.3 mM NaHCO₃, 0.1 mM NaNO₃ and 0.1 mM Na₂SO₄ with an initial molar ratio of SO₄²⁻ to ClO₄⁻ equal to 10.0. The high background electrolyte (Electrolyte 2) consisted of a solution of 1.0 mM NaCl, 3.0 mM NaHCO₃, 1.0 mM NaNO₃ and 1.0 mM Na₂SO₄ with an initial molar ratio of SO₄²⁻ to ClO₄⁻ equal to 100.0. FIG. 19 compares the uptake of perchlorate by the G5-NH₂ PPI dendrimer in deionized water and electrolytes. In the low background electrolyte solution, the maximum EOB (˜6.0) decreases by a factor of 1.5 compared to that observed in deionized water (˜9.0) at pH 4.0. At pH 4.0, FIG. 19 shows a large decrease of the maximum EOB of perchlorate (˜2.0) in the high background electrolyte solution compared to that observed in deionized water (˜9.0) at anion-dendrimer loading of ˜32.0. At pH 9.0, the maximum EOB of perchlorate in deionized water (˜2.20) is comparable to that in the low background electrolyte solution (˜1.95). However, it is ˜1.78 times larger than the measured EOB of perchlorate (˜1.10) in the high background electrolyte solution. Recall that the initial molar ratio of SO₄²⁻ to ClO₄⁻ in the high background electrolyte solution is equal to 100. Thus, the presence of “excess” amounts of SO₄²⁻ anions in solution has a significant impact on perchlorate uptake by the G5-NH₂ PPI dendrimer.

The preferential binding of divalent anions (e.g. SO₄²⁻) over monovalent anions (e.g. ClO₄⁻) is well known in the case of IEX resins with quaternary alkyl ammonium groups. Barron and Fritz, J. Chrom. (1994), 316:201-210, coined the term “electroselectivity” to explain the preference for divalent anions over monovalent ions in these systems. In the remediation of perchlorate contamination of water by non-selective ion exchange resins, the preferential binding of ions other than perchlorate can present a significant problem, reducing the efficiency of the process by forcing the operation of more frequent resin regeneration cycles.

Since the dendrimer-enhanced perchlorate removal methods of the invention also exhibited interference by sulfate, overcoming sulfate electroselectivity became a key objective. It was thought that the relatively hydrophilic G4-NH₂ PAMAM dendrimer might provide a more favorable environment for SO₄²⁻ than the hydrophobic G5-NH2 PPI dendrimer. If this were the case, it might be possible to sequester SO₄²⁻ with the PAMAM dendrimer in the presence of the PPI dendrimer, leaving the latter free to bind ClO₄⁻ with reduced interference. To test this hypothesis, measurements of ClO₄⁻ uptake by G5-NH₂ PPI in the presence of G4-NH2 PAMAM dendrimers in the high background electrolyte solution were carried out. The molar ratio of SO₄²⁻ to PAMAM dendrimer was varied, to provide solutions with sulfate-dendrimer loadings equal to those of perchlorate-dendrimer loadings used in previous experiments (FIGS. 16, 16 and 19).

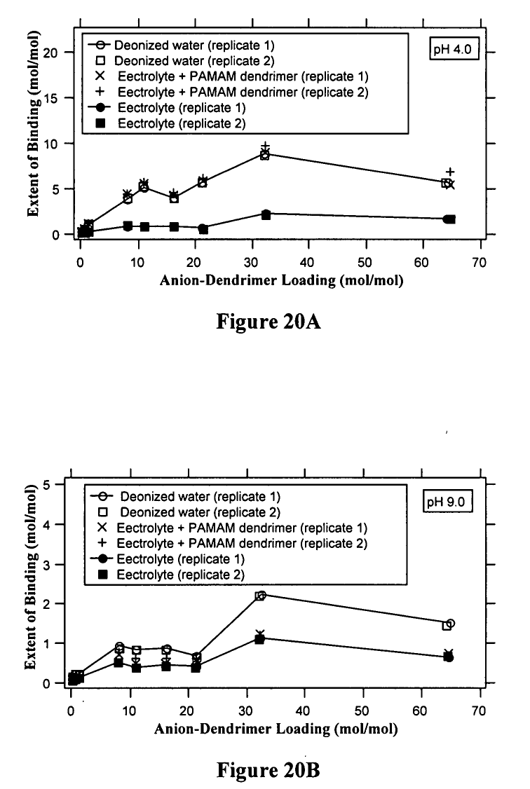

The results show that, at pH 4.0, addition of the G4-NH₂ PAMAM dendrimer in the high background electrolyte solution suppressed the effect of SO₄²⁻ on perchlorate uptake by the G5-NH₂ PPI dendrimer (FIG. 20). When the G4-NH₂ PAMAM dendrimer is present, the EOB and FB of ClO₄⁻ in the high background electrolyte are the same as in deionized water. At pH 9.0, however, the addition of the PAMAM dendrimer has no effect on perchlorate uptake in the high background electrolyte solution. At pH 9.0, the tertiary amine groups of the G4-NH₂ PAMAM dendrimer are neutral (Table 9), suggesting that the suppression of the sulfate effect on the PPI dendrimer in the high background electrolyte solution involves SO₄²⁻ binding to the protonated tertiary amine groups of the G4-NH₂ PAMAM dendrimer. These results also provide indirect evidence that (i) the G5-NH₂ PPI dendrimer selectively binds ClO₄⁻ over more hydrophilic anions such as Cl⁻, NO₃⁻, SO₄²⁻ and HCO₃⁻ and (ii) the SO₄²⁻ anions bound to the G4-PAMAM dendrimer can be released by deprotonation of its tertiary amine groups.

### Example 5

### Extent of Binding of Fe(III) in Aqueous Solution

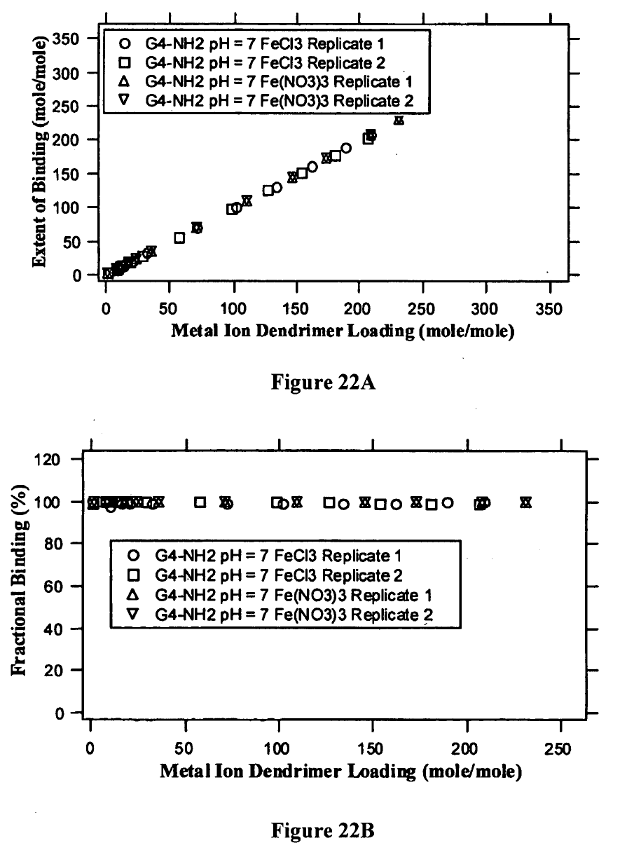

FIG. 22 shows the extent of binding and fractional binding of Fe(III) in aqueous solutions of G4-NH₂ EDA core PAMAM dendrimer at pH 7.0. Data were obtained using procedures shown by Diallo et al. (2004) Langmuir. 20:2640. These data indicate that most or all of the Fe is bound to the dendrimers.

### Example 6

### Synthesis of Zero Valent Iron PAMAM Dendrimer Nanocomposites

Fe(0) (zero valent iron) nanocomposites were prepared by reduction of aqueous complexes of Fe(III) with a generation 4 (G4-NH₂) polyamido(amine) (PAMAM) dendrimer with ethylene diamine (EDA) core and terminal NH₂ groups at pH 7.0. The overall process involves adding Fe(III) to the interior of dendrimers and reducing the Fe(III) to Fe(0) with a reductant such as sodium borohydride, producing dendrimers having Fe(0) deposited inside. The process leaves the surface groups of the dendrimers unmodified so that they can be used for other reactions, such as attachment to a solid surface. The resulting Fe(0) nanocomposite comprises Fe(0) nanoparticles dispersed within the dendrimer. The utility of the nanocomposite was demonstrated by using the Fe(0) nanocomposite to reductively dehalogenate perchloroethylene (PCE).

The synthesis of Fe(0) PAMAM dendrimer nanocomposites was carried in 8 mL borosilicate glass vials at pH 7.0 by reacting 4 mL of aqueous solutions Fe(III)-dendrimer complexes with excess sodium borohydride (2000 ppm). The ability of the Fe(0) dendrimer nanocomposites (94 ppm of Fe(III) and molar ratio Fe(III)-NH₂ 0.125) to reduce the amounts PCE (10 ppm) in aqueous solutions was evaluated using gas chromatography (GC) with electron capture detector (ECD) and flame ionization detector (FID).

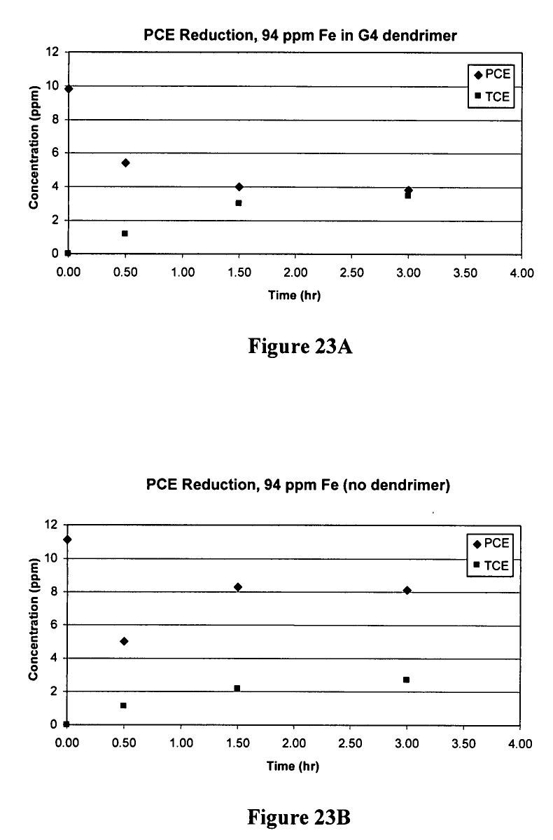

The Fe(0)-containing nanocomposites are used to convert PCE to trichloroethylene (TCE) (FIG. 23A). The control reaction (FIG. 23B) contains Fe(0) but no dendrimers. Preliminary investigations showed significant reduction of PCE (40-60% after 3 hours) by the Fe(0)-PAMAM dendrimer nanocomposites. Conversely, only 20% of the 10 ppm of PCE was reduced in aqueous solutions in the control Fe(0) particles synthesized by reduction of 94 ppm Fe(III) with 2000 ppm of sodium borohydride.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of removing ions from an aqueous fluid containing said ions, comprising:
contacting the aqueous fluid with an amount of a dendrimer agent sufficient to bind at least a portion of the ions in the fluid, to produce a quantity of dendrimer-bound ions; and
filtering the dendrimer-bound ions from the fluid,
whereby a quantity of filtered fluid is produced, and
wherein the ions are metal cations or metal ate-complex anions selected from the group consisting of the cations and ate-complex anions of cobalt, nickel, lead, cadmium, zinc, mercury, iron, chromium, silver, gold, cadmium, iron, palladium, platinum, gadolinium, uranium, and arsenic.

2. The method of claim 1, wherein the ions are selected from the group consisting of metal cations of nickel, iron, cobalt, and silver.

3. The method of claim 1, wherein the ions are selected from the group consisting of ate- complex anions of arsenic, chromium, uranium, gold, platinum, and palladium.

4. A method of removing anions from an aqueous fluid containing said ions, comprising:
contacting the aqueous fluid with an amount of a dendrimer agent sufficient to bind at least a portion of the anions in the fluid, to produce a quantity of dendrimer-bound anions; and
filtering the dendrimer-bound anions from the fluid,
whereby a quantity of filtered fluid is produced.

5. The method of claim 4, wherein the anions are selected from the group consisting of perchlorate, chromate, and arsenate.

6. A method of removing a first anion from an aqueous fluid containing said first anion and at least a second anion, comprising:
contacting the aqueous fluid with an amount of a first dendrimer agent sufficient to bind at least a portion of said first anion, and simultaneously
contacting the aqueous fluid with an amount of a second dendrimer agent having binding affinity for said second ion, under conditions such that the extent of binding of said first anion to said first dendrimer agent is increased by the binding of the second anion to the second dendrimer agent, to produce a quantity of dendrimer-bound first anion and a quantity of dendrimer-bound second anion; and
filtering the dendrimer-bound anions from the fluid,
whereby a quantity of filtered fluid is produced.

7. The method of any one of claims 1, 4, or 6, wherein the step of filtering the dendrimer-bound ions comprises using a process selected from the group consisting ultrafiltration, nanofiltration, or microfiltration.

8. The method of claim 7, wherein at least one dendrimer agent comprises a quantity of a tecto-dendrimer.

9. The method of claim 7, wherein at least one dendrimer agent comprises a quantity of a linear-dendritic copolymer.

10. The method of claim 7, wherein at least one dendrimer agent comprises a dendrimer having a plurality of amino groups.

11. The method of claim 7, further comprising subjecting the dendrimer-bound ions to a recycling reaction to separate at least a portion of the ions from at least a portion of the dendrimers, to produce a quantity of ions and a quantity of unbound dendrimers.

12. The method of claim 11, further comprising re-using the quantity of unbound dendrimers according to the method of claim 1.

13. A method of reducing halogenated hydrocarbons in water, comprising
(a) contacting a quantity of water containing halogenated hydrocarbons with an Fe(0)-containing nanocomposite, wherein said Fe(0) nanocomposite comprises Fe(0) nanoparticles dispersed within a dendrimer, and
(b) filtering the nanocomposite from the water, thereby producing water with a reduced level of halogenated hydrocarbon.

14. A water filtration system, comprising:
a reaction unit including a quantity of a dendrimer agent; and
a filtration unit in fluid communication with the reaction unit.

15. The water filtration system of claim 14, wherein the filtration unit comprises a filter selected from the group consisting of nanofilters, ultrafilters, microfilters, and combinations thereof.

16. The water filtration system of claim 14, wherein the reaction unit and the filtration unit are integrated.

17. The water filtration system of claim 14, wherein the dendrimer agent comprises a quantity of a tecto-dendrimer.

18. The water filtration system of claim 14, wherein the dendrimer agent comprises a quantity of a linear-dendritic copolymer.

19. The water filtration system of claim 14, wherein the dendrimer agent comprises a quantity of a dendrimer selected from the group consisting of cation-binding dendrimers, anion-binding dendrimers, organic compound-binding dendrimers, redox-active dendrimers, biological compound-binding dendrimers, catalytic dendrimers, biocidal dendrimers, viral-binding dendrimers, multi-functional dendrimers, and combinations thereof.

20. The water filtration system of claim 14, further comprising a dendrimer recovery unit in fluid communication with the filtration unit and configured to implement a recycling reaction, wherein the dendrimer-bound ions are released from the dendrimer agent and the dendrimer agent thus obtained is filtered from the released ions and re-used in the reaction unit.
